(19) United States
(12) Patent Application Publication
(10) Pub. No.: US 2026/0322410 A1
(43) Pub. Date: Oct. 15, 2026

(54) RADIO FREQUENCY MODULE AND COMMUNICATION APPARATUS

(71) Applicant: Murata Manufacturing Co., Ltd., Nagaokakyo-shi (JP)

(72) Inventors: Masahide TAKEBE, Nagaokakyo-shi (JP); Kensuke TAKIMOTO, Nagaokakyo-shi (JP); Kunitoshi HANAOKA, Nagaokakyo-shi (JP); Masaki KIMURA, Nagaokakyo-shi (JP); Naru MORITO, Nagaokakyo-shi (JP); Hiroyuki NAGAMORI, Nagaokakyo-shi (JP); Kouichi UENO, Nagaokakyo-shi (JP); Masakazu HIROBE, Nagaokakyo-shi (JP)

(73) Assignee: Murata Manufacturing Co., Ltd., Nagaokakyo-shi (JP)

(21) Appl. No.: 19/687,117

(22) Filed: May 26, 2026

Related U.S. Application Data
(63) Continuation of application No. PCT/JP2024/039822, filed on Nov. 8, 2024.

(30) Foreign Application Priority Data
Dec. 22, 2023 (JP) 2023-216399

(51) Int. Cl. H04B 1/00; H04W 84/06

(52) U.S. Cl. CPC H04B 1/0057; H04W 84/06

(57) ABSTRACT

A radio frequency module includes an antenna terminal, switching circuitry, a first filter, and a second filter. The switching circuitry is connected to each of the antenna terminal, the first filter, and the second filter. The first filter has a first passband including a transmission band of a non-terrestrial network. The second filter has a second passband including both a reception band of the non-terrestrial network and a reception band of a terrestrial network.

### CROSS-REFERENCE TO RELATED APPLICATIONS

The present application is a continuation application of International Application No. PCT/JP2024/039822, filed on Nov. 8, 2024, which claims priority to Japanese Patent Application No. 2023-216399, filed on Dec. 22, 2023. The entire contents of these applications are incorporated herein by reference.

### TECHNICAL FIELD

The present disclosure typically relates to a radio frequency module and a communication apparatus, and in more detail, relates to a radio frequency module and a communication apparatus that support terrestrial communication bands and non-terrestrial communication bands.

### BACKGROUND ART

A front-end module (radio frequency module) described in Patent Document 1 includes a wideband filter, a transmission filter, and switches. The wideband filter allows, to pass therethrough, both of a reception signal in a first communication frequency band (for example, Band 20) and a reception signal in a second communication frequency band (for example, Band 28). The transmission filter allows, to pass therethrough, a transmission signal in the first communication frequency band or a transmission signal in the second communication frequency band. Each switch selectively connects to the wideband filter or the transmission filter. As described above, the front-end module above supports terrestrial communication bands (for example, Band 20 and Band 28).

### CITATION LIST

### Patent Document

Patent Document 1: International Publication No. 2019/176538

### SUMMARY

A radio frequency module according to an aspect of the present disclosure includes an antenna terminal, switching circuitry, a first filter, and a second filter. The switching circuitry is connected to each of the antenna terminal, the first filter, and the second filter. The first filter has a first passband including a transmission band of a non-terrestrial network. The second filter has a second passband including both a reception band of the non-terrestrial network and a reception band of a terrestrial network.

A radio frequency module according to an aspect of the present disclosure includes a switch, a first duplexer, and at least one or more second duplexers or one or more filters. The first duplexer is connected to the switch. The first duplexer has a transmission filter and a reception filter. The transmission filter has a passband including a transmission band of n255. The reception filter has a passband including a reception band of at least one of Band 75, Band 76, or Band 32, and a reception band of n255.

A radio frequency module according to an aspect of the present disclosure includes an antenna terminal, a first switch, a first filter, and a second filter. The first switch has a first common terminal, a first selection terminal, and a second selection terminal. The first common terminal is connected to the antenna terminal. The first selection terminal and the second selection terminal are connectable to the first common terminal. The first filter is connected to the first selection terminal. The second filter is connected to the second selection terminal. The first passband of the first filter includes the transmission band of the first communication band that serves as the communication band in a non-terrestrial network. The second passband of the second filter includes a reception band of the first communication band and a reception band of the second communication band. The second communication band is a communication band in a terrestrial network.

A communication apparatus according to an aspect of the present disclosure includes a radio frequency module and a signal processing circuit. The signal processing circuit is connected to the radio frequency module and performs signal processing on a radio frequency signal.

### BRIEF DESCRIPTION OF DRAWINGS

FIG. 1 is a block diagram of a radio frequency module and a communication apparatus according to Embodiment 1.

FIG. 2 is an enlarged partial diagram of the radio frequency module.

FIG. 3 is an enlarged partial diagram of a radio frequency module according to Modification 1 of Embodiment 1.

FIG. 4 is an enlarged partial diagram of a radio frequency module according to Embodiment 2.

FIG. 5 is an enlarged partial diagram of a radio frequency module according to Embodiment 3.

FIG. 6 is an enlarged partial diagram of a radio frequency module according to Embodiment 4.

FIG. 7 is an enlarged partial diagram of a radio frequency module according to Modification 1 of Embodiment 4.

FIG. 8 is a block diagram of a radio frequency module according to Embodiment 5.

FIG. 9 is a block diagram of a radio frequency module according to Modification 1 of Embodiment 5.

FIG. 10 is a block diagram of a radio frequency module according to Modification 2 of Embodiment 5.

FIG. 11 is a block diagram of a radio frequency module according to Embodiment 6.

FIG. 12 is a block diagram of a radio frequency module according to Embodiment 7.

FIG. 13 is a block diagram of a radio frequency module according to Embodiment 8.

FIG. 14 is a block diagram of a radio frequency module according to Embodiment 9.

### DESCRIPTION OF EMBODIMENTS

### Technical Problem

In recent years, a concept of using non-terrestrial network (NTN) technology has been proposed. In the concept, communication in low-coverage areas (such as mountainous regions, ocean surfaces, and remote islands) at a level comparable to that in urban areas may be achieved by utilizing communication with communication satellites or high altitude platform stations (HAPS). To embody the concept, causing the front-end module that supports the reception band of the terrestrial communication band as described in Patent Document 1 to further support the reception band of a non-terrestrial communication band (n255) has been proposed.

However, the inventors have recognized that causing the front-end module that supports the reception band of the terrestrial communication band to further support the reception band of the non-terrestrial communication band leads to the necessity for additionally providing a reception filter dedicated to the reception band of the non-terrestrial communication band. There thus arises an issue of upsizing the front-end module.

In view of the issue above, the present disclosure is directed to providing a radio frequency module and a communication apparatus that support the reception band of the terrestrial communication band and the reception band of the non-terrestrial communication band. In some embodiments, such a radio frequency module may be configured compactly.

### Embodiment 1

A radio frequency module 1 and a communication apparatus 25 according to Embodiment 1 will be described in detail with reference to the drawings.

### (1) Overview

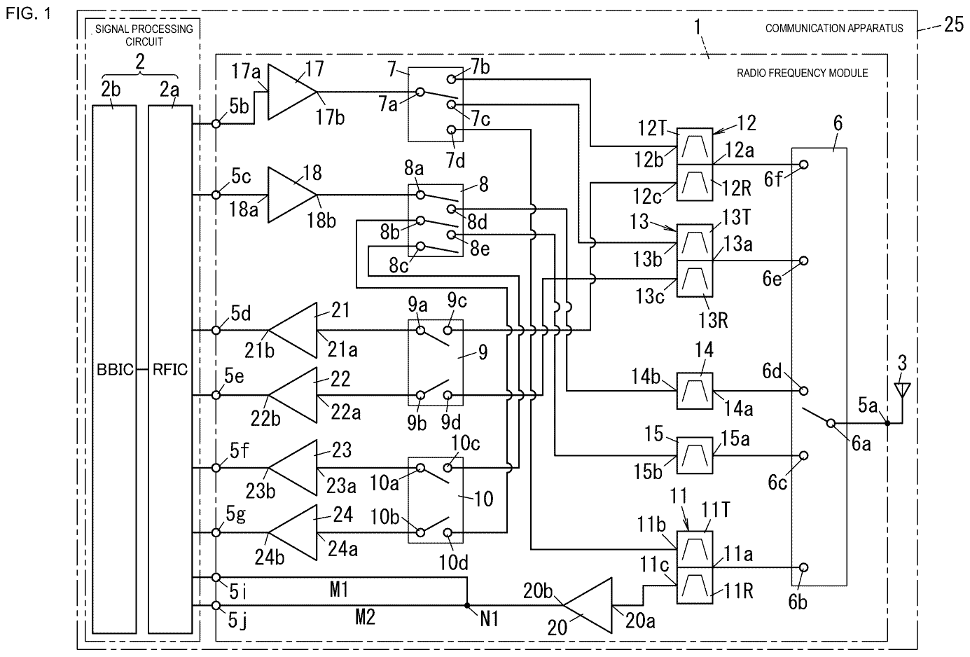

As illustrated in FIG. 1, the radio frequency module 1 according to Embodiment 1 includes a switch 6, a first duplexer 11, at least one or more (in the example in FIG. 1, two) second duplexers 12 and 13 or at least one or more (in the example in FIG. 1, two) filters 14 and 15. The first duplexer 11 is connected to the switch 6. The first duplexer 11 has a transmission filter 11T and a reception filter 11R. The transmission filter 11T has a passband including a transmission band of n255. The reception filter has a passband including a reception band of at least one of Band 75, Band 76, or Band 32 and a reception band of n255.

With this configuration, the reception band of at least one of Band 75, Band 76, or Band 32 (hereinafter, described as Band 75/Band 76/Band 32) and the reception band of n255 may be co-banded by using a reception filter. The term “co-banding” denotes that a plurality of communication bands are included in a passband of one filter (the reception filter 11R in Embodiment 1). The reception filter 11R thus includes the reception band of n255 and the reception band of Band 75/Band 76/Band 32 in the passband thereof. Accordingly, the radio frequency module may be configured compactly as compared with a case where a reception filter supporting the reception band of n255 and a reception filter supporting the reception band of Band 75/Band 76/Band 32 are provided separately.

### (2) Configuration of Communication Apparatus

As illustrated in FIG. 1, the communication apparatus 25 is a communication apparatus including the radio frequency module 1. The communication apparatus 25 is, for example, a mobile terminal (for example, a smartphone); however, the communication apparatus 25 is not limited to a mobile terminal and may be, for example, a wearable terminal (for example, a smart watch). The radio frequency module 1 is a module capable of supporting, for example, a 4G (fourth-generation mobile communication) standard and a 5G (fifth-generation mobile communication) standard. The 4G standard is, for example, the third generation partnership project (3GPP) (registered trademark) or the long term evolution (LTE) (registered trademark) standard. The 5G standard is, for example, 5G new radio (NR).

The communication apparatus 25 includes a signal processing circuit 2 and an antenna 3 in addition to the radio frequency module 1.

The radio frequency module 1 is configured to amplify a reception signal (radio frequency signal) received at the antenna 3 and output the signal to the signal processing circuit 2. The radio frequency module 1 is also configured to amplify a transmission signal (radio frequency signal) output from the signal processing circuit 2 and transmit the signal from the antenna 3. The radio frequency module 1 is controlled by, for example, the signal processing circuit 2.

The signal processing circuit 2 is connected to the radio frequency module 1 and is configured to perform signal processing on the reception signal output from the radio frequency module 1. The signal processing circuit 2 is also configured to perform signal processing on the transmission signal to be output to the radio frequency module 1. The signal processing circuit 2 includes a radio frequency (RF) signal processing circuit 2a and a baseband signal processing circuit 2b.

The RF signal processing circuit 2a is, for example, a radio frequency integrated circuit (RFIC) and performs signal processing on radio frequency signals (a transmission signal and a reception signal). The RF signal processing circuit 2a performs signal processing such as downconverting on the reception signal output from the radio frequency module 1 and outputs the signal to the baseband signal processing circuit 2b. The RF signal processing circuit 2a performs signal processing such as upconverting on the transmission signal output from the baseband signal processing circuit 2b and outputs the signal to the radio frequency module 1.

The baseband signal processing circuit 2b is, for example, a baseband integrated circuit (BBIC). The baseband signal processing circuit 2b outputs the reception signal output from the RF signal processing circuit 2a to the outside. The output signal (reception signal) is usable, for example, as an image signal, for image displaying or, as an audio signal, for a talk. The baseband signal processing circuit 2b also generates a transmission signal from the baseband signal (for example, the audio signal and the image signal) input from the outside and outputs the generated transmission signal to the RF signal processing circuit 2a.

### (3) Configuration of Radio Frequency Module

As illustrated in FIG. 1, the radio frequency module 1 includes a plurality of external terminals 5a to 5g, 5i, and 5j and a plurality of electronic components. In the example in FIG. 1, the plurality of electronic components includes switches 6 to 10, the first duplexer 11, the one or more (in the example in FIG. 1, two) second duplexers 12 and 13, the one or more (in the example in FIG. 1, two) filters 14 and 15, one or more (in the example in FIG. 1, two) power amplifiers 17 and 18, and one or more (in the example in FIG. 1, five) low-noise amplifiers 20 to 24.

The external terminal 5a is an antenna terminal to which the antenna 3 is connected. The antenna terminal 5a described herein is not limited to an external port of a communication apparatus, but includes any conductive junction, terminal pin, or mounting pad on the radio frequency module substrate suitable for receiving or transmitting a radio frequency signal. External terminals 5b and 5c are connected to an output part of the signal processing circuit 2 and are input terminals to which an output signal (transmission signal) from the output part of the signal processing circuit 2 is input. The external terminals 5d to 5g, 5i, and 5j are connected to an input part of the signal processing circuit 2 and are output terminals that output a reception signal processed by the radio frequency module 1 to the input part of the signal processing circuit 2.

The phrase “A is connected to B” referred to in herein is not limited to a case where A is directly connected but also includes a case where A is indirectly connected to B with another electronic component or conductive element interposed therebetween. The phrase “A is connected to B” also denotes that A and B are connected to be conductive (in other words, electrically).

The switch 6 is an antenna switch. The switch 6 selects a connection target for the external terminal 5a from among the first duplexer 11, the second duplexers 12 and 13, and the filters 14 and 15. The switch 6 is, for example, a switch integrated circuit (IC). The switch 6 has a common terminal 6a and a plurality of (in the example in FIG. 1, five) selection terminals 6b to 6f. The common terminal 6a is selectively connectable to at least one of the plurality of selection terminals 6b to 6f. The common terminal 6a is connected to the external terminal 5a. The selection terminal 6b is connected to an input/output part 11a (described later) of the first duplexer 11. The selection terminal 6c is connected to a first input/output part 15a (described later) of the filter 15. The selection terminal 6d is connected to a first input/output part 14a (described later) of the filter 14. The selection terminal 6e is connected to an input/output part 13a (described later) of the second duplexer 13. The selection terminal 6f is connected to an input/output part 12a (described later) of the second duplexer 12.

The switch 7 is a band selection switch. The switch 7 selects a connection target for an output part 17b of the power amplifier 17 from among the transmission filters 11T, 12T, and 13T (described later). The switch 7 is, for example, a switch integrated circuit (IC). The switch 7 has a common terminal 7a and a plurality of (in the example in FIG. 1, three) selection terminals 7b, 7c, and 7d. The common terminal 7a is selectively connectable to at least one of the plurality of selection terminals 7b, 7c, and 7d. The common terminal 7a is connected to the output part 17b of the power amplifier 17. The selection terminal 7b is connected to an input part 12b (described later) of the transmission filter 12T. The selection terminal 7c is connected to an input part 13b (described later) of the transmission filter 13T. The selection terminal 7d is connected to an input part 11b (described later) of the transmission filter 11T.

The switch 8 is a band selection switch. The switch 8 selects a connection target for the output part 18b of the power amplifier 18 from among the filters 14 and 15. The switch 8 also selects connection targets for common terminals 8b and 8c (described later) from among the filters 14 and 15. The switch 8 is, for example, a switch integrated circuit (IC). The switch 8 has a common terminal 8a and the common terminals 8b and 8c the number of which is plural (in the example in FIG. 1, three) and a plurality of (in the example in FIG. 1, two) selection terminals 8d and 8e. The plurality of common terminals 8a to 8c are each selectively connectable to at least one of the plurality of selection terminals 8d and 8e. The common terminal 8a is connected to an output part 18b (described later) of the power amplifier 18. The common terminals 8b and 8c are respectively connected to selection terminals 10c and 10d (described later) of a switch 10. The selection terminal 8d is connected to a second input/output part 14b (described later) of the filter 14. The selection terminal 8e is connected to a second input/output part 15b (described later) of the filter 15.

The switch 9 selects connection targets for respective input parts 21a and 22a of low-noise amplifiers 21 and 22 from among reception filters 12R and 13R (described later). The switch 9 is, for example, a switch integrated circuit (IC). The switch 9 has a plurality of (in the example in FIG. 1, two) common terminals 9a and 9b and a plurality of (in the example in FIG. 1, two) selection terminals 9c and 9d. The plurality of common terminals 9a and 9b are each selectively connectable to at least one of the plurality of selection terminals 9c and 9d. The common terminal 9a is connected to the input part 21a of the low-noise amplifier 21. The common terminal 9b is connected to the input part 22a of the low-noise amplifier 22. The selection terminal 9c is connected to an output part 12c of the reception filter 12R (described later). The selection terminal 9d is connected to an output part 13c of the reception filter 13R (described later).

The switch 10 selects connection targets for respective input parts 23a and 24a of low-noise amplifiers 23 and 24 from among the common terminals 8b and 8c of the switch 8. The switches 8 and 10 thus select the connection targets for the respective input parts 23a and 24a of the low-noise amplifiers 23 and 24 from among the filters 14 and 15. The switch 10 is, for example, a switch integrated circuit (IC). The switch 10 has a plurality of (in the example in FIG. 1, two) common terminals 10a and 10b and the plurality of (in the example in FIG. 1, two) selection terminals 10c and 10d. The plurality of common terminals 10a and 10b are each selectively connectable to at least one of the plurality of selection terminals 10c and 10d. The common terminal 10a is connected to the input part 23a of the low-noise amplifier 23. The common terminal 10b is connected to the input part 24a of the low-noise amplifier 24. The selection terminals 10c and 10d are respectively connected to the common terminals 8b and 8c of the switch 8.

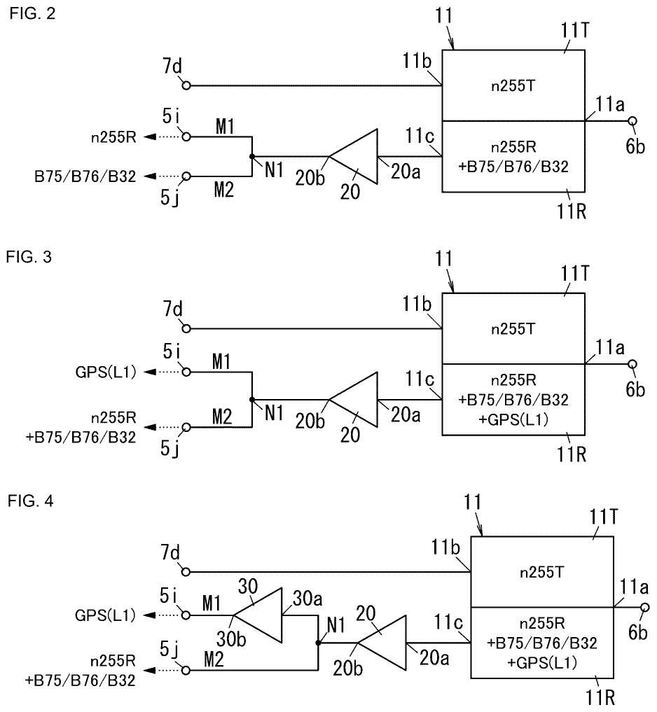

The first duplexer 11 is a frequency division duplex (FDD) filter. As illustrated in FIG. 2, the first duplexer 11 has the transmission filter 11T and the reception filter 11R. The transmission filter 11T has a passband including a non-terrestrial n255 transmission band (also described as n255T). n255T ranges from 1626.5 MHz to 1660.5 MHz. The reception filter 11R has a passband including a reception band of at least one of terrestrial Band 75, Band 76, or Band 32 (hereinafter, also described as a reception band of Band 75/Band 76/Band 32 on occasions) and a reception band of non-terrestrial n255 (also described as n255R). Band 75 ranges from 1432 MHz to 1517 MHz. Band 76 ranges from 1427 MHz to 1432 MHz. Band 32 ranges from 1452 MHz to 1496 MHz. n255R ranges from 1525 MHz to 1559 MHz.

The first duplexer 11 has the input/output part 11a, the input part 11b, and an output part 11c. The input/output part 11a functions as an output part of the transmission filter 11T and an input part of the reception filter 11R. The input/output part 11a is connected to the selection terminal 6b of the switch 6. The input part 11b functions as an input part of the transmission filter 11T. The input part 11b is connected to the selection terminal 7d of the switch 7. The output part 11c functions as an output part of the reception filter 11R. The output part 11c is connected to an input part 20a of the low-noise amplifier 20.

The transmission filter 11T receives a signal (transmission signal) from the input part 11b, limits the received signal to a signal in an uplink communication band of n255, allows the limited signal to pass therethrough, and outputs the signal allowed to pass therethrough from the input/output part 11a. The reception filter 11R receives a signal (reception signal) from the input/output part 11a, limits the received signal to a signal in the communication bands of n255R, Band 75, Band 76, and Band 32, allows the limited signal to pass therethrough, and outputs the signal allowed to pass therethrough from the output part 11c.

The second duplexer 12 is a FDD filter. The second duplexer 12 is a duplexer different from the first duplexer 11. The second duplexer 12 is a duplexer that supports a terrestrial signal. The second duplexer 12 has the transmission filter 12T and the reception filter 12R. The transmission filter 12T has the passband including the transmission band of the terrestrial first communication band. The transmission band of a first communication band is, for example, Band 1T or Band 3T. The reception filter 12R has a passband including a reception band of a terrestrial second communication band. The second communication band may be a communication band that is the same as or different from the first communication band. The reception band of the second communication band is, for example, Band 1R or Band 3R.

The second duplexer 12 has the input/output part 12a, the input part 12b, and the output part 12c. The input/output part 12a functions as an output part of the transmission filter 12T and the input part of the reception filter 12R. The input/output part 12a is connected to the selection terminal 6f of the switch 6. The input part 12b functions as an input part of the transmission filter 12T. The input part 12b is connected to the selection terminal 7b of the switch 7. The output part 12c functions as an output part of the reception filter 12R. The output part 12c is connected to the selection terminal 9c of the switch 9.

The transmission filter 12T receives a signal (transmission signal) from the input part 12b, limits the received signal to a signal in the transmission band of the first communication band, allows the limited signal to pass therethrough, and outputs the signal allowed to pass therethrough from the input/output part 12a. The reception filter 12R receives a signal (reception signal) from the input/output part 12a, limits the received signal to a signal in the reception band of the second communication band, allows the limited signal to pass therethrough, and outputs the signal allowed to pass therethrough from the output part 12c.

The second duplexer 13 is a FDD filter. The second duplexer 13 is a duplexer different from the first duplexer 11. The second duplexer 13 is a duplexer that supports a terrestrial signal. The second duplexer 13 has the transmission filter 13T and the reception filter 13R. The transmission filter 13T has a passband including a transmission band of a terrestrial third communication band. The transmission band of the third communication band is, for example, Band 25T or Band 66T+Band 70T. The reception filter 13R has a passband including a reception band of a terrestrial fourth communication band. The fourth communication band may be a communication band that is the same as or different from the third communication band. The reception band of the fourth communication band is, for example, Band 25R+Band 70R or Band 66R.

The second duplexer 13 has the input/output part 13a, the input part 13b, and the output part 13c. The input/output part 13a functions as an output part of the transmission filter 13T and the input part of the reception filter 13R. The input/output part 13a is connected to the selection terminal 6e of the switch 6. The input part 13b functions as an input part of the transmission filter 13T. The input part 13b is connected to the selection terminal 7c of the switch 7. The output part 13c functions as an output part of the reception filter 13R. The output part 13c is connected to the selection terminal 9d of the switch 9.

The transmission filter 13T receives a signal (transmission signal) from the input part 13b, limits the received signal to a signal in the transmission band of the third communication band, allows the limited signal to pass therethrough, and outputs the signal allowed to pass therethrough from the input/output part 13a. The reception filter 13R receives a signal (reception signal) from the input/output part 13a, limits the received signal to a signal in the reception band of the fourth communication band, allows the limited signal to pass therethrough, and outputs the signal allowed to pass therethrough from the output part 13c.

The filter 14 is, for example, a time division duplex (TDD) filter. The filter 14 is, for example, a transmission/reception filter. The filter 14 has a passband including a transmission band and a reception band of a terrestrial fifth communication band. The fifth transmission band is, for example, a communication band that is one of Band 34, Band 39, Band 40, and Band 41. The filter 14 has the first input/output part 14a and the second input/output part 14b. The first input/output part 14a is connected to the selection terminal 6d of the switch 6. The second input/output part 14b is connected to the selection terminal 8d of the switch 8. The filter 14 receives a signal (reception signal) from the first input/output part 14a, limits the received signal to a signal in the reception band of the fifth communication band, allows the limited signal to pass therethrough, and outputs the signal allowed to pass therethrough from the second input/output part 14b. The filter 14 also receives a signal (transmission signal) from the second input/output part 14b, limits the received signal to a signal in the transmission band of the fifth communication band, allows the limited signal to pass therethrough, and outputs the signal allowed to pass therethrough from the first input/output part 14a.

The filter 15 is a TDD filter. The filter 15 is, for example, a transmission/reception filter. The filter 15 has a passband including a transmission band and a reception band of a terrestrial sixth communication band. The sixth communication band is a communication band different from the fifth communication band and that is one of, for example, Band 34, Band 39, Band 40, and Band 41. The filter 15 has the first input/output part 15a and the second input/output part 15b. The first input/output part 15a is connected to the selection terminal 6c of the switch 6. The second input/output part 15b is connected to the selection terminal 8e of the switch 8. The filter 15 receives a signal (reception signal) from the first input/output part 15a, limits the received signal to a signal in the reception band of the sixth communication band, allows the limited signal to pass therethrough, and outputs the signal allowed to pass therethrough from the second input/output part 15b. The filter 15 also receives a signal (transmission signal) from the second input/output part 15b, limits the received signal to a signal in the transmission band of the sixth communication band, allows the limited signal to pass therethrough, and outputs the signal allowed to pass therethrough from the first input/output part 15a.

The power amplifier 17 is provided between the external terminal 5b and the common terminal 7a of the switch 7. The power amplifier 17 has an input part 17a and the output part 17b. The input part 17a is connected to the external terminal 5b. The output part 17b is connected to the common terminal 7a of the switch 7. The power amplifier 17 amplifies a signal (transmission signal) input to the input part 17a and outputs the amplified signal from the output part 17b.

The power amplifier 18 is provided between the external terminal 5c and the common terminal 8a of the switch 8. The power amplifier 18 has an input part 18a and the output part 18b. The input part 18a is connected to the external terminal 5c. The output part 18b is connected to the common terminal 8a of the switch 8. The power amplifier 18 amplifies a signal (transmission signal) input to the input part 18a and outputs the amplified signal from the output part 18b.

The low-noise amplifier 20 is provided between the output part 11c of the reception filter 11R and a branch point N1 (see FIG. 2). The branch point N1 is a physical conductive junction connected to the external terminal 5i with a first signal path M1 interposed therebetween and is connected to the external terminal 5j with a second signal path M2 interposed therebetween. The low-noise amplifier 20 has the input part 20a and an output part 20b. The input part 20a is connected to the output part 11c of the reception filter 11R. The output part 20b is connected to the branch point N1. The low-noise amplifier 20 amplifies a signal (reception signal) input to the input part 20a and outputs the amplified signal from the output part 20b. The output signal from the output part 20b is thereby output to the external terminal 5i via the branch point N1 and the first signal path M1 and is output to the external terminal 5j via the branch point N1 and the second signal path M2.

The first signal path M1 is a signal path to transmit the received signal in the communication band of n255 to the signal processing circuit 2. The signal flowing from the branch point N1 through the first signal path M1 is output from the external terminal 5i to the signal processing circuit 2. From the output signal, a signal in n255 is then extracted in the signal processing circuit 2. The second signal path M2 is a signal path to transmit the received signal in Band 75/Band 76/Band 32 to the signal processing circuit 2. The signal flowing from the branch point N1 through the second signal path M2 is output from the external terminal 5j to the signal processing circuit 2. From the output signal, a signal in Band 75/Band 76/Band 32 is then extracted in the signal processing circuit 2.

The low-noise amplifier 21 is provided between the common terminal 9a of the switch 9 and the external terminal 5d. The low-noise amplifier 21 has the input part 21a and an output part 21b. The input part 21a is connected to the common terminal 9a of the switch 9. The output part 21b is connected to the external terminal 5d. The low-noise amplifier 21 amplifies a signal (reception signal) input to the input part 21a and outputs the amplified signal from the output part 21b.

The low-noise amplifier 22 is provided between the common terminal 9b of the switch 9 and the external terminal 5e. The low-noise amplifier 22 has the input part 22a and an output part 22b. The input part 22a is connected to the common terminal 9b of the switch 9. The output part 22b is connected to the external terminal 5e. The low-noise amplifier 22 amplifies a signal (reception signal) input to the input part 22a and outputs the amplified signal from the output part 22b.

The low-noise amplifier 23 is provided between the common terminal 10a of the switch 10 and the external terminal 5f. The low-noise amplifier 23 has the input part 23a and an output part 23b. The input part 23a is connected to the common terminal 10a of the switch 10. The output part 23b is connected to the external terminal 5f. The low-noise amplifier 23 amplifies a signal (reception signal) input to the input part 23a and outputs the amplified signal from the output part 23b.

The low-noise amplifier 24 is provided between the common terminal 10b of the switch 10 and the external terminal 5g. The low-noise amplifier 24 has the input part 24a and an output part 24b. The input part 24a is connected to the common terminal 10b of the switch 10. The output part 24b is connected to the external terminal 5g. The low-noise amplifier 24 amplifies a signal (reception signal) input to the input part 24a and outputs the amplified signal from the output part 24b.

### (4) Features of Radio Frequency Module 1

The radio frequency module 1 supports the terrestrial communication bands (such as Band 1, Band 3, Band 7, Band 25, Band 32, Band 40, Band 41, Band 70, Band 66, Band 75, and Band 76) and the non-terrestrial communication band (n255). In more detail, the radio frequency module 1 includes the components (the reception filter 11R, the second duplexers 12 and 13, and the filters 14 and 15) supporting the terrestrial communication bands and the components (the reception filter 11R and the transmission filter 11T) supporting the non-terrestrial communication band. Co-banding the non-terrestrial communication band (n255) and a terrestrial communication band (for example, a communication band of Band 75/Band 76/Band 32) relatively close to the non-terrestrial communication band causes at least a subset (for example, the reception filter 11R) of the components supporting the terrestrial communication bands to doubly serve as a component (reception filter 11R) supporting the non-terrestrial communication band.

Further, the doubly serving of the reception filter 11R also leads to the doubly serving of the low-noise amplifier 20 downstream of the reception filter 11R for a terrestrial communication band and a non-terrestrial communication band.

### (5) Operations of Radio Frequency Module 1

Operations of a feature component (first duplexer 11) of the radio frequency module 1 will be described with reference to FIG. 1.

### (5-1) Operations in Receiving Signal in Each of Plurality of Co-Banded Communication Bands

In the switch 6, the common terminal 6a is connected to the selection terminal 6b. In response to the antenna 3 receiving a signal in this state, the received signal (reception signal) flows through the antenna 3, the switch 6, the reception filter 11R of the first duplexer 11, and the low-noise amplifier 20 in order and is output to the branch point N1. At this time, the reception signal is limited to a signal in the passband of the reception filter 11R by the reception filter 11R and amplified by the low-noise amplifier 20.

The signal output to the branch point N1 is then divided at the branch point N1 and flows to the first signal path M1 and the second signal path M2. The signal passing through the first signal path M1 is output from the external terminal 5i to the signal processing circuit 2. From the signal output from the external terminal 5i to the signal processing circuit 2, a signal in co-banded Band 75/Band 76/Band 32 is removed in the signal processing circuit 2, and a signal in n255 is extracted. The signal passing through the second signal path M2 is output from the external terminal 5j to the signal processing circuit 2. From the signal output from the external terminal 5j to the signal processing circuit 2, a signal in co-banded n255 is removed in the signal processing circuit 2, and a signal in Band 75/Band 76/Band 32 is extracted.

### (5-2) Operations in Transmitting Signal in n255T

In the switch 7, the common terminal 7a is connected to the selection terminal 7d. In addition, in the switch 6, the common terminal 6a is connected to the selection terminal 6b. In this state, a transmission signal is input from the signal processing circuit 2 to the external terminal 5b. The transmission signal input to the external terminal 5b then flows through the power amplifier 17, the switch 7, and the transmission filter 11T and is output to the selection terminal 6b of the switch 6. At this time, the transmission signal is amplified by the power amplifier 17 and is limited to the signal in the passband of the transmission filter 11T by the transmission filter 11T. The transmission signal output to the selection terminal 6b of the switch 6 is then output from the switch 6 to the antenna 3 and is transmitted from the antenna 3.

(6) Features and Operation The radio frequency module 1 according to Embodiment 1 includes the switch 6, the first duplexer 11, and at least one or more second duplexers 12 and 13 or one or more filters 14 and 15. The first duplexer 11 is connected to the switch 6. The first duplexer 11 has the transmission filter 11T and the reception filter 11R. The transmission filter 11T has the passband including the transmission band of n255. The reception filter 11R has the passband including the reception band of at least one of Band 75, Band 76, or Band 32 and the reception band of n255.

With this configuration, the reception band of at least one of Band 75, Band 76, or Band 32 (hereinafter, also described as Band 75/Band 76/Band 32) and the reception band of n255 may be co-banded by using the reception filter 11R. The term “co-banding” denotes that a plurality of communication bands are included in a passband of one filter. The passband of the reception filter (11R) thus includes the reception band of n255 and the reception band of Band 75/Band 76/Band 32. Accordingly, as compared with a case where the reception filter that supports the reception band of n255 and the reception filter that supports the reception band of Band 75/Band 76/Band 32 are separately provided, the radio frequency module 1 may be configured compactly.

The communication apparatus 25 according to Embodiment 1 includes the radio frequency module 1 and the signal processing circuit 2. The signal processing circuit 2 is connected to the radio frequency module 1 and performs signal processing on a radio frequency signal. With this configuration, the communication apparatus having the features and operation of the radio frequency module may be provided.

### (7) Modification

A modification of Embodiment 1 will be described. Hereinafter, description of the same configuration as that in Embodiment 1 is omitted, and a configuration different from that in Embodiment 1 is mainly described on occasions.

### (7-1) Modification 1

### (7-1-1) Configuration

As illustrated in FIG. 3, the passband of a reception filter 11R in Modification 1 further includes a communication band (for example, L1) for a global navigation satellite system (GNSS), such as a global positioning system (GPS), in the passband of the reception filter 11R in Embodiment 1. The passband of the reception filter 11R in Modification 1 thus includes the reception band of n255R, the reception band of at least one of Band 75, Band 76, or Band 32 (hereinafter, described as “Band 75/Band 76/Band 32), and the communication band for GPS. The communication band of L1 ranges from 1574.397 MHz to 1576.442 MHz and is a communication band relatively close to the terrestrial communication bands (for example, Band 75, Band 76, and Band 32) among communication bands used for GPS satellites. In other words, in Modification 1, the reception band of n255R, the reception band of Band 75/Band 76/Band 32, and the communication band (for example, L1) for GPS are co-banded.

Due to the co-banding, the passband of the reception filter 11R in Modification 1 includes the reception band of the terrestrial communication band (the communication band of Band 75/Band 76/Band 32), the reception band of non-terrestrial n255, and the communication band (for example, L1) for GPS.

The low-noise amplifier 20 in Modification 1 serves as the low-noise amplifier that supports the terrestrial communication band (bandwidth of Band 75/Band 76/Band 32), the low-noise amplifier that supports non-terrestrial n255, and the low-noise amplifier that supports the communication band for GPS.

In Modification 1, from the signal output from the external terminal 5i to the signal processing circuit 2, a signal in the communication band for GPS is extracted in the signal processing circuit 2. In addition, from the signal output from the external terminal 5j to the signal processing circuit 2, a signal in the reception band of n255R and a signal in the reception band of Band 75/Band 76/Band 32 are extracted in the signal processing circuit 2.

### (7-1-2) Features and Operation

In the radio frequency module 1 according to Modification 1, the passband of the reception filter 11R further includes the communication band (for example, L1) for GPS. With this configuration, as compared with a case where the reception filter that supports the communication band for GPS is separately provided, the radio frequency module may be configured compactly.

### Embodiment 2

### (1) Configuration

A radio frequency module 1 according to Embodiment 2 will be described with reference to FIG. 4. Hereinafter, the low-noise amplifier 20 according to Modification 1 of Embodiment 1 is described as a first low-noise amplifier 20.

As illustrated in FIG. 4, the radio frequency module 1 according to Embodiment 2 is configured similarly to the radio frequency module 1 according to Modification 1 of Embodiment 1 (see FIG. 3) except that the radio frequency module 1 according to Embodiment 2 further includes a second low-noise amplifier 30. Hereinafter, description of the same configuration as that in Modification 1 of Embodiment 1 is omitted, and a configuration different from that in Modification 1 described above is mainly described.

The second low-noise amplifier 30 is provided on the first signal path M1. In more detail, the second low-noise amplifier 30 is connected between the branch point N1 and the external terminal 5i. In more detail, the second low-noise amplifier 30 has an input part 30a and an output part 30b. The input part 30a is connected to the branch point N1. The input part 30a is thus connected to the output part 20b of the first low-noise amplifier 20 with the branch point N1 interposed therebetween. The output part 30b is connected to the external terminal 5i. The second low-noise amplifier 30 amplifies a signal input to the input part 30a such that a signal in the communication band for GPS included in the signal has a predetermined signal strength (for example, signal strength appropriate for demodulation) and outputs the amplified signal from the output part 30b.

### (2) Operations

Hereinafter, description of the same operations as those in the operations in Modification 1 of Embodiment 1 is omitted, and operations different from those in Modification 1 described above will be mainly described.

Operations in receiving a signal in each of a plurality of co-banded communication bands will be described. The following description assumes that the received signal strength of a signal in the communication band for GPS is lower than the received signal strength of a signal in any of the remaining communication bands (n255, Band 75, Band 76, and Band 32). Hereinafter, on occasions, a signal in the communication band for GPS of a plurality of co-banded communication bands is described as a first signal, and a signal in one of the remaining communication bands (n255, Band 75, Band 76, and Band 32) is described as a second signal.

In the switch 6, the common terminal 6a is connected to the selection terminal 6b. In response to the antenna 3 receiving a signal in this state, the received signal (reception signal) flows through the antenna 3, the switch 6, the reception filter 11R, and the first low-noise amplifier 20 in order and is output to the branch point N1, like the operations in Embodiment 1. At this time, the reception signal is amplified by the first low-noise amplifier 20. The amplification causes the signals in the plurality of communication bands that are included in the reception signal to be amplified, for example, at the same amplification factor. The amplification causes the second signal included in the reception signal to be amplified to a predetermined signal strength (for example, signal strength appropriate for demodulation). However, the received signal strength of the first signal is lower than the received signal strength of the second signal and thus is not amplified to the predetermined signal strength (for example, the signal strength appropriate for demodulation). The predetermined signal strength described above of the second signal is assumed to be the same strength as the predetermined signal strength described above of the first signal but may be a different strength.

The signal output to the branch point N1 is divided at the branch point N1 and flows therefrom to the first signal path M1 and the second signal path M2. The reception signal passing through the first signal path M1 is then further amplified by the second low-noise amplifier 30. The amplification causes the signal strength of the first signal included in the reception signal to be amplified to the predetermined signal strength (for example, the signal strength appropriate for demodulation). The reception signal amplified by the second low-noise amplifier 30 then flows through the first signal path M1 and is output from the external terminal 5i to the signal processing circuit 2. The signal processing circuit 2 then extracts the signal in the communication band for GPS from the reception signal output from the external terminal 5i and demodulates the extracted signal. In the demodulation, the first signal included in the reception signal has been amplified to have the predetermined signal strength and is thus reliably demodulated by the signal processing circuit 2.

The reception signal passing through the second signal path M2 is output from the external terminal 5j to the signal processing circuit 2. The signal processing circuit 2 extracts the second signal from the reception signal output from the external terminal 5j and demodulates the extracted signal. In the demodulation, the second signal included in the reception signal has been amplified to have the predetermined signal strength and is thus reliably demodulated by the signal processing circuit 2.

In Embodiment 2, the first low-noise amplifier 20 amplifies the respective signals in the plurality of co-banded communication bands, for example, at the same amplification factor. However, the received signal strength (−130 dBm or lower) of the signal in the communication band for GPS of the respective signals in the plurality of co-banded communication bands is lower than the received signal strength of the signal in any of the remaining communication bands (for example, the received signal strength of the n255 communication band is approximately −110 dBm). Accordingly, if the first low-noise amplifier 20 amplifies the signal in the remaining communication band to have the predetermined signal strength, the signal in the communication band for GPS is not amplified to have the predetermined signal strength. Accordingly, the second low-noise amplifier 30 further amplifies the signal in the communication band for GPS, and thereby the signal in the communication band for GPS is amplified to have the predetermined signal strength. In this manner, the combination of the first low-noise amplifier 20 and the second low-noise amplifier 30 causes the respective signals in the plurality of communication bands described above to be amplified to have the predetermined signal strength.

### (3) Features and Operation

The radio frequency module 1 according to Embodiment 2 further includes the first low-noise amplifier 20, the first signal path M1 and the second signal path M2, and the second low-noise amplifier 30. The first low-noise amplifier 20 is connected to the reception filter 11R. The second low-noise amplifier 30 is provided on the first signal path M1 and amplifies the signal in the communication band for GPS, the first signal path M1 and the second signal path M2 branching downstream of the first low-noise amplifier 20.

With this configuration, each signal in a corresponding one of the plurality of co-banded communication bands (GPS (L1), n255, Band 75, Band 76, and Band 32) may be amplified by the shared first low-noise amplifier 20. The signal in the communication band for GPS that passes through the first signal path M1 may also be amplified by the second low-noise amplifier 30. Even if the received signal strength of the signal in the communication band for GPS is lower than the received signal strength of the remaining communication bands (n255, Band 75, Band 76, and Band 32), the first low-noise amplifier 20 and the second low-noise amplifier 30 may thereby amplify each signal in a corresponding one of the plurality of communication bands described above to have a signal strength appropriate for signal processing (for example, demodulation).

### (4) Modification

A modification of Embodiment 2 will then be described. Hereinafter, description of the same configuration as that in Embodiment 2 is omitted, and a configuration different from that in Embodiment 2 is mainly described.

### (4-1) Modification 1

In Modification 1, in the operations of the second low-noise amplifier 30 in Embodiment 2, the second low-noise amplifier 30 further amplifies a reception signal such that the signal strength of a second signal (a signal in any of the remaining communication bands) that serves as an unwanted wave when a first signal (a signal in the communication band for GPS) is demodulated in the signal processing circuit 2 becomes lower than the signal strength of the first signal. In Modification 1, the second low-noise amplifier 30 thus amplifies the reception signal such that the first signal is amplified to have a predetermined signal strength and that the signal strength of the second signal to serve as the unwanted wave becomes lower than the signal strength of the first signal.

In more detail, in Modification 1, the gain curve of the second low-noise amplifier 30 has been controlled such that the first signal is amplified to have the predetermined signal strength and that the signal strength of the second signal becomes lower than the signal strength of the first signal.

In Modification 1, as described above, the second low-noise amplifier 30 amplifies the reception signal such that the first signal is amplified to have the predetermined signal strength and that the signal strength of the second signal to serve as the unwanted wave becomes lower than the signal strength of the first signal. For this reason, the signal strength of the second signal to serve as the unwanted wave is lower than the signal strength of the first signal when the signal processing circuit 2 performs signal processing (for example, demodulation) on the first signal included in the reception signal output from the external terminal 5i, and thus signal processing (for example, demodulation) may be performed on the first signal more reliably.

In Modification 1, the gain curve of the second low-noise amplifier 30 is controlled, and thereby the reception signal is amplified such that the first signal is amplified to have the predetermined signal strength and that the signal strength of the second signal to serve as the unwanted wave becomes lower than the signal strength of the first signal. However, the method by which the reception signal is amplified in this manner is not limited to the method by which the gain curve of the second low-noise amplifier 30 is controlled. For example, as the method by which the reception signal is amplified as described above, a method in which a first capacitor and a second capacitor (illustration omitted) are provided upstream of the input part 30a of the second low-noise amplifier 30 may also be used. In this method, the first capacitor described above is connected in series to the first signal path M1. The second capacitor described above is connected between the first signal path M1 and the ground. As the method by which the reception signal is amplified as described above, a method in which a notch filter is provided upstream of the input part 30a of the second low-noise amplifier 30 may also be used.

### Embodiment 3

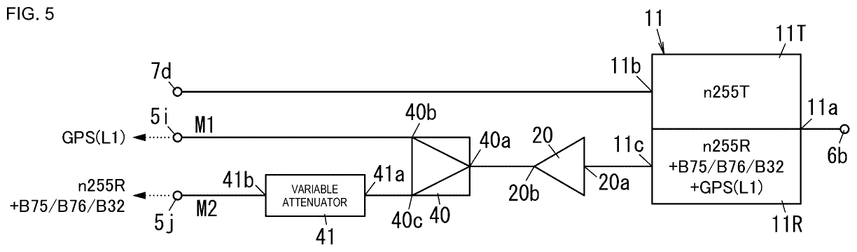

A radio frequency module 1 according to Embodiment 3 will be described with reference to FIG. 5.

### (1) Configuration

As illustrated in FIG. 5, the radio frequency module 1 according to Embodiment 3 is configured similarly to the radio frequency module 1 according to Modification 1 of Embodiment 1 (see FIG. 3) except that the radio frequency module 1 according to Embodiment 3 further includes a demultiplexer 40 (also referred to as a splitter) and a variable attenuator 41 (also referred to as a variable attenuator). Hereinafter, description of the same configuration as that in Modification 1 of Embodiment 1 is omitted, and a configuration different from that in Modification 1 described above is mainly described.

The demultiplexer 40 demultiplexes the first signal and the second signal from the output signal from the low-noise amplifier 20. The first signal is a signal in the communication band for GPS. The second signal is a signal in any of the communication bands (n255, Band 75, Band 76, and Band 32) other than the communication band for GPS among a plurality of co-banded communication bands.

The demultiplexer 40 has an input part 40a, a first output part 40b, and a second output part 40c. The input part 40a is connected to the output part 20b of the low-noise amplifier 20. The first output part 40b is connected to the external terminal 5i with the first signal path M1 interposed therebetween. The second output part 40c is connected to the external terminal 5j with the second signal path M2 interposed therebetween. The demultiplexer 40 demultiplexes the first signal from the output signal from the low-noise amplifier 20 input to the input part 40a and outputs the demultiplexed first signal, from the first output part 40b to the first signal path M1. The demultiplexer 40 also demultiplexes the second signal from the output signal from the low-noise amplifier 20 input to the input part 40a and outputs the demultiplexed second signal, from the second output part 40c to the second signal path M2.

The variable attenuator 41 attenuates the second signal output to the second signal path M2. In more detail, the variable attenuator 41 is provided on the second signal path M2. The variable attenuator 41 has an input part 41a and an output part 41b. The input part 41a is connected to the second output part 40c of demultiplexer 40 with part of the second signal path M2 interposed therebetween. The output part 41b is connected to the external terminal 5j with the remaining part of the second signal path M2 interposed therebetween. The variable attenuator 41 attenuates the second signal input to the input part 41a and outputs, from the output part 41b, the attenuated second signal. In accordance with the control of a predetermined controller or a manual setting operation, the variable attenuator 41 is capable of controlling attenuation in attenuating the signal (second signal) input to the input part 41a.

### (2) Operations

Hereinafter, description of the same operations as those in the operations in Modification 1 of Embodiment 1 is omitted, and operations different from those in Modification 1 described above will be mainly described.

Operations in receiving a signal in each of a plurality of co-banded communication bands will be described. The following description assumes that the received signal strength of the first signal is lower than the received signal strength of the second signal.

In the switch 6, the common terminal 6a is connected to the selection terminal 6b. In response to the antenna 3 receiving a signal in this state, the received signal (reception signal)flows through the antenna 3, the switch 6, the reception filter 11R of the first duplexer 11, and the low-noise amplifier 20 in order and is output to the demultiplexer 40. At this time, the reception signal is amplified by the low-noise amplifier 20. The amplification causes the respective signals in the plurality of communication bands included in the reception signal to be amplified, for example, at the same amplification factor. The amplification causes the first signal included in the reception signal to be amplified to have a predetermined signal strength (for example, a signal strength appropriate for demodulation) and the second signal included in the reception signal to be amplified to have a signal strength higher than the predetermined signal strength.

The demultiplexer 40 then demultiplexes the first signal and the second signal from the reception signal. The demultiplexed first signal passes through the first signal path M1 from the demultiplexer 40 and is output from the external terminal 5i to the signal processing circuit 2. The signal processing circuit 2 performs signal processing (for example, demodulation) on the first signal output from the external terminal 5i. In the signal processing, the first signal has been amplified to have the predetermined signal strength (for example, the signal strength appropriate for the signal processing), and thus the signal processing is performed on the first signal reliably.

The second signal demultiplexed by the demultiplexer 40 passes through the second signal path M2 from the demultiplexer 40 and is output to the variable attenuator 41. The second signal output to the variable attenuator 41 is attenuated by the variable attenuator 41 to have a predetermined signal strength. The second signal attenuated by the variable attenuator 41 is then output from the external terminal 5j to the signal processing circuit 2. The signal processing circuit 2 performs signal processing (for example, demodulation) on the second signal output from the external terminal 5j. In the signal processing, the second signal has been amplified to have the predetermined signal strength (for example, the signal strength appropriate for the signal processing), and thus the signal processing is performed reliably on the second signal.

### (3) Features and Operation

The radio frequency module 1 according to Embodiment 3 includes the low-noise amplifier 20, the demultiplexer 40, and the variable attenuator 41. The low-noise amplifier 20 is connected to the output part 11c of the reception filter 11R. The demultiplexer 40 demultiplexes the first signal in the communication band for GPS that is included in the output signal from the low-noise amplifier 20 and outputs the demultiplexed first signal to the first signal path M1. The demultiplexer 40 also demultiplexes the second signal in at least one communication band of n255, Band 75, Band 76, or Band 32 and outputs the demultiplexed second signal to the second signal path M2, the second signal being included in the output signal from the low-noise amplifier 20. The variable attenuator 41 is provided on the second signal path M2 and attenuates the second signal.

With this configuration, each signal in a corresponding one of the plurality of co-banded communication bands (GPS (L1), n255, Band 75, Band 76, and Band 32) may be amplified by the shared low-noise amplifier 20. The radio frequency module 1 may thereby be configured compactly. In addition, the second signal demultiplexed to the second signal path M2 by the demultiplexer 40 may be attenuated by the variable attenuator 41. Even if the received signal strength of the signal in the communication band for GPS is lower than the received signal strength of the remaining communication bands (n255, Band 75, Band 76, and Band 32), each signal in a corresponding one of the plurality of co-banded communication bands may thereby be amplified to have the signal strength appropriate for the signal processing (for example, demodulation). As a result, the signal processing may be performed reliably on each signal in a corresponding one of the plurality of communication bands described above.

### (4) Modification

A modification of Embodiment 3 will then be described. Hereinafter, description of the same configuration as that in Embodiment 3 is omitted, and a configuration different from that in Embodiment 3 is mainly described.

### (4-1) Modification 1

In a radio frequency module 1 according to Modification 1, a variable attenuator is provided also on the first signal path M1 in the radio frequency module 1 according to Embodiment 3. That is, in the radio frequency module 1 according to Modification 1, the respective variable attenuators are provided on the first signal path M1 and the second signal path M2.

In Modification 1, the low-noise amplifier 20 amplifies an output signal from the reception filter 11R to have a signal strength higher than a predetermined signal strength. The variable attenuator provided on the first signal path M1 attenuates the signal in the communication band for GPS (first signal) that passes through the first signal path M1 to have a predetermined signal strength. The variable attenuator 41 provided on the second signal path M2 attenuates the signal (second signal) in any of the remaining communication bands to have a predetermined signal strength. As described above, each signal in a corresponding one of the plurality of co-banded communication bands is amplified to have the signal strength appropriate for the signal processing (for example, demodulation). As a result, the signal processing may be performed reliably on each signal in a corresponding one of the plurality of communication bands described above. The predetermined signal strength described above of the second signal is assumed to be the same signal strength as the predetermined signal strength described above of the first signal but may be a different signal strength.

### Embodiment 4

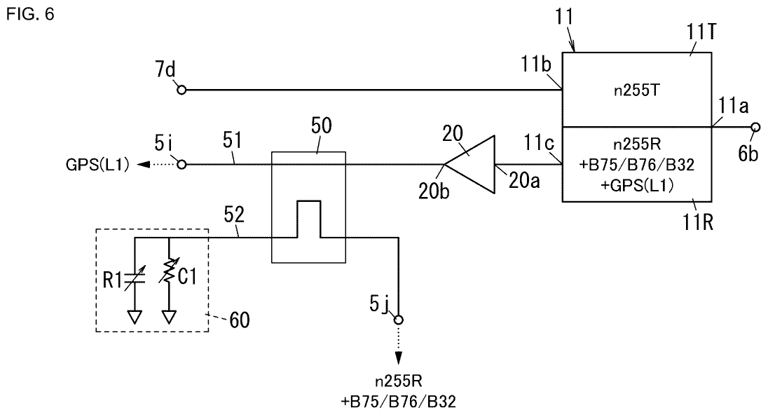

A radio frequency module 1 according to Embodiment 4 will be described with reference to FIG. 6.

### (1) Configuration

A radio frequency module 1 according to Embodiment 4 is configured similarly to the radio frequency module 1 according to Modification 1 of Embodiment 1 (see FIG. 3) except that the radio frequency module 1 according to Embodiment 4 further includes a coupler 50 and a variable element 60. Hereinafter, description of the same configuration as that in Modification 1 of Embodiment 1 is omitted, and a configuration different from that in Modification 1 described above is mainly described.

The coupler 50 demultiplexes a second signal other than a first signal from an output signal from the low-noise amplifier 20. The first signal is a signal in the communication band for GPS. The second signal is a signal in any of the communication bands (n255, Band 75, Band 76, and Band 32) other than the communication band for GPS among the plurality of co-banded communication bands.

The coupler 50 has a main line 51 and a sub line 52. The main line 51 is a signal path connecting the output part 20b of the low-noise amplifier 20 and the external terminal 5i. The sub line 52 is a signal path away from the main line 51 and has electromagnetic coupling with the main line 51. The sub line 52 is connected to the variable element 60. In the example in FIG. 6, the variable element 60 is provided on one end of the sub line 52. The other end of the sub line 52 (an end opposite from the one end described above) is connected to the external terminal 5j. An output signal from the low-noise amplifier 20 flows through the main line 51 and is output from the external terminal 5i to the signal processing circuit 2. By using the electromagnetic coupling acting between the main line 51 and the sub line 52, the coupler 50 demultiplexes the second signal included in the output signal from the low-noise amplifier 20 that passes through the main line 51, and outputs the demultiplexed second signal to the sub line 52. For example, on the sub line 52, the coupler 50 outputs the demultiplexed second signal toward the other end of the sub line 52 (the end connected to the external terminal 5j).

The variable element 60 is a variable element provided on the sub line 52 (for example, one end of the sub line 52) and for controlling the coupling amount of the electromagnetic coupling between the main line 51 and the sub line 52. The variable element 60 is capable of controlling the coupling amount described above in accordance with the control of a predetermined controller or a manual setting operation. The variable element 60 is at least one of, for example, a variable resistor R1 or a variable capacitor C1. The variable resistor R1 is connected between one end of the sub line 52 and the ground. The variable capacitor C1 is connected between one end of the sub line 52 and the ground. In the example in FIG. 6, the case of providing both the variable resistor R1 and the variable capacitor C1 is illustrated. However, only one of the variable resistor R1 and the variable capacitor C1 may be provided. In addition, the variable resistor R1 and the variable capacitor C1 are connected in parallel to each other in the example in FIG. 6 but may be connected in series to each other.

### (2) Operations

Hereinafter, description of the same operations as those in the operations in Modification 1 of Embodiment 1 is omitted, and operations different from those in Modification 1 described above will be mainly described.

In the switch 6, the common terminal 6a is connected to the selection terminal 6b. In response to the antenna 3 receiving a signal in this state, the received signal (reception signal) flows through the antenna 3, the switch 6, the reception filter 11R of the first duplexer 11, the low-noise amplifier 20, and the main line 51 in order and is output from the external terminal 5i to the signal processing circuit 2. At this time, the reception signal is amplified by the low-noise amplifier 20. The signal processing circuit 2 then performs signal processing on the reception signal from the external terminal 5i. In more detail, the signal processing circuit 2 extracts the first signal from the reception signal from the external terminal 5i and demodulates the extracted first signal. The coupler 50 demultiplexes the second signal included in the reception signal passing through the main line 51 and outputs the demultiplexed second signal to the sub line 52. The second signal output to the sub line 52 is output from the external terminal 5j to the signal processing circuit 2. The signal processing circuit 2 performs the signal processing (for example, demodulation) on the second signal from the external terminal 5j.

### (3) Features and Operation

The radio frequency module 1 according to Embodiment 4 includes the low-noise amplifier 20, the coupler 50, and the variable element 60. The low-noise amplifier 20 is connected to the reception filter 11R. The coupler 50 has the main line 51 and the sub line 52. The main line 51 is connected to the low-noise amplifier 20. The sub line 52 has the electromagnetic coupling with the main line 51. The variable element 60 is a variable element provided on the sub line 52 and for controlling the coupling amount of the electromagnetic coupling between the main line 51 and the sub line 52. The coupler 50 demultiplexes the signal in at least one communication band of n255, Band 75, Band 76, or Band 32 from the output signal from the low-noise amplifier 20 that passes through the main line 51, and outputs the demultiplexed signal to the sub line 52.

With this configuration, each signal in a corresponding one of the plurality of co-banded communication bands (GPS (L1), n255, Band 75, Band 76, and Band 32) may be amplified by the shared low-noise amplifier 20. The radio frequency module 1 may thereby be configured compactly. In addition, the coupling amount of the electromagnetic coupling between the main line 51 and the sub line 52 may be controlled by the variable element 60.

### (4) Modifications

Modifications of Embodiment 4 will then be described. Hereinafter, description of the same configuration as that in Embodiment 4 is omitted, and a configuration different from that in Embodiment 4 is mainly described.

### (4-1) Modification 1

### (4-1-1) Configuration

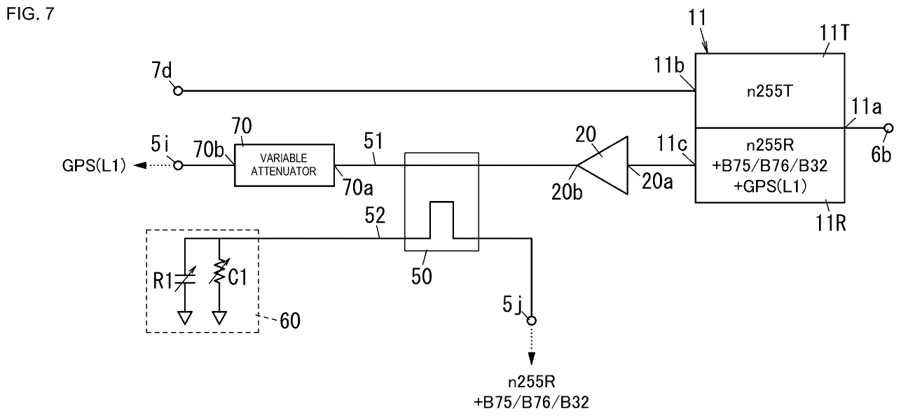

As illustrated in FIG. 7, a radio frequency module 1 according to Modification 1 is configured similarly to the radio frequency module 1 according to Embodiment 4 except that a point that the radio frequency module 1 according to Modification 1 further includes a variable attenuator 70. Hereinafter, description of the same configuration as that in Embodiment 4 is omitted with the same reference numerals, and a configuration different from that in Embodiment 4 is mainly described.

The variable attenuator 70 attenuates an output signal from the low-noise amplifier 20 that passes through the main line 51 downstream of the coupler 50. The variable attenuator 70 thus attenuates the signal output from the external terminal 5i. In more detail, the variable attenuator 70 is provided on the main line 51 and downstream of the coupler 50. The variable attenuator 70 has an input part 70a and an output part 70b. The input part 70a is connected to the output part 20b of the low-noise amplifier 20 with part of the main line 51 interposed therebetween. The output part 70b is connected to the external terminal 5i with the remaining part of the main line 51 interposed therebetween. The variable attenuator 70 attenuates the signal (the output signal from the low-noise amplifier 20) input to the input part 70a and outputs, from the output part 70b, the attenuated signal. In accordance with the control of a predetermined controller or a manual setting operation, variable attenuator 70 is capable of controlling the attenuation of the signal input to the input part 70a.

### (4-1-2) Operations

Operations in receiving a signal in each of a plurality of co-banded communication bands will be described. The following description assumes that the received signal strength of a signal in the communication band for GPS (first signal) is lower than the received signal strength of a signal (second signal) in any of the remaining communication bands (n255, Band 75, Band 76, and Band 32).

In the switch 6, the common terminal 6a is connected to the selection terminal 6b. In response to the antenna 3 receiving the signal in this state, the received signal (reception signal) is output to the main line 51 via the antenna 3, the switch 6, the reception filter 11R of the first duplexer 11, and the low-noise amplifier 20 in order. At this time, the reception signal is amplified by the low-noise amplifier 20. The amplification causes the signal strength of each of the first signal and the second signal included in the reception signal to be larger than a predetermined signal strength (signal processing (for example, a signal strength appropriate for demodulation)). The reception signal output to the main line 51 is attenuated by the variable attenuator 70 and thereafter is output from the external terminal 5i. In the reception signal, the attenuation by the variable attenuator 70 causes the signal strength of the first signal included in the reception signal to be attenuated to the predetermined signal strength. The signal processing circuit 2 then performs signal processing on the reception signal from the external terminal 5i, thereby extracts the first signal from the reception signal, and demodulates the extracted first signal. The first signal has been amplified to have the predetermined signal strength, and thus the signal processing (for example, demodulation) is performed reliably on the first signal.

On the main line 51, by using the electromagnetic coupling between the main line 51 and the sub line 52, the coupler 50 demultiplexes the second signal included in the reception signal passing through a portion between the low-noise amplifier 20 and the variable attenuator 70 and outputs the demultiplexed second signal to the sub line 52. The signal strength of the second signal demultiplexed by the coupler 50 is attenuated to the predetermined signal strength due to the demultiplexing. The second signal attenuated to have the predetermined signal strength flows through the sub line 52 and is output from the external terminal 5j to the signal processing circuit 2. The signal processing circuit 2 performs the signal processing (for example, demodulation) on the second signal from the external terminal 5i. The second signal has been amplified to have the predetermined signal strength, and thus the signal processing (for example, demodulation) is performed reliably on the second signal.

### (4-1-3) Features and Operation

The radio frequency module 1 according to Modification 1 includes the variable attenuator 70. The variable attenuator 70 is provided on the main line 51 and attenuates the output signal from the low-noise amplifier 20 that passes through the main line 51. With this configuration, the output signal from the reception filter 11R may be amplified by the low-noise amplifier 20 such that the second signal (n255, Band 75, Band 76, and Band 32) extracted from the sub line 52 has the signal strength appropriate for the signal processing. The output signal from the low-noise amplifier 20 may also be attenuated by the variable attenuator 70 such that the first signal (the signal in the communication band for GPS) extracted from the main line 51 has the signal strength appropriate for the signal processing. As a result, each signal in a corresponding one of the plurality of co-banded communication bands (GPS (L1), n255, Band 75, Band 76, and Band 32) may be amplified to have the signal strength appropriate for the signal processing.

### (4-2) Modification 2

In Modification 1 of Embodiment 4, the case where the variable attenuator 70 is provided on the main line 51 and the variable element 60 is provided on the sub line 52 has been exemplified. In contrast, in Modification 2, the variable element 60 is provided on the main line 51, and the variable attenuator 70 is provided on the sub line 52. In this case, the low-noise amplifier 20 amplifies the output signal from the reception filter 11R such that the signal strength of the first signal included in the output signal from the reception filter 11R (reception signal) has a predetermined signal strength. The signal processing circuit 2 then extracts the first signal from the reception signal output from the external terminal 5i and demodulates the extracted first signal. At this time, the first signal has been amplified to have the predetermined signal strength and thus is demodulated reliably. The variable attenuator 70 provided on the sub line 52 attenuates the second signal demultiplexed to the sub line 52 by the coupler 50 to have a predetermined signal strength. The signal processing circuit 2 demodulates the second signal output from the external terminal 5j. At this time, the second signal has been attenuated to have the predetermined signal strength by the variable attenuator 70 and thus is demodulated reliably. The predetermined signal strength described above of the second signal is assumed to be the same signal strength as the predetermined signal strength described above of the first signal but may be a different signal strength.

Also in Modification 2, like Modification 1, each signal in a corresponding one of the plurality of co-banded communication bands (GPS (L1), n255, Band 75, Band 76, and Band 32) may be amplified to have the signal strength appropriate for the signal processing.

### Embodiment 5

### (1) Configuration

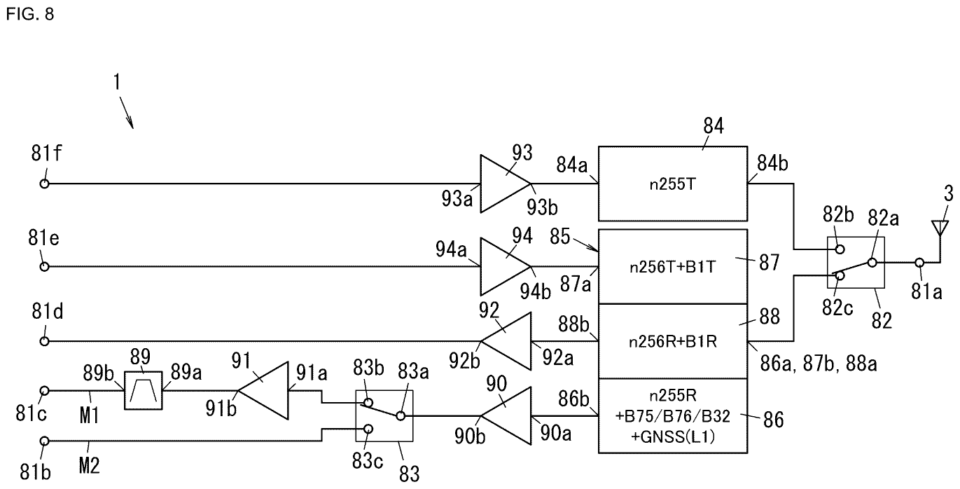

A radio frequency module 1 according to Embodiment 5 will be described with reference to FIG. 8.

The radio frequency module 1 according to Embodiment 5 includes external terminals 81a to 81f, a first switch 82, a second switch 83, a first filter 84, a second filter 86, a third filter 89, a fourth filter 87, a fifth filter 88, a first low-noise amplifier 90, a second low-noise amplifier 91, and a third low-noise amplifier 92.

The external terminal 81a is an antenna terminal to which the antenna 3 is connected. The external terminals 81b, 81c, and 81d are connected to mutually different input parts of the signal processing circuit (illustration omitted) and are each an output terminal that outputs a reception signal processed by the radio frequency module 1 to the input part of the signal processing circuit described above. The external terminals 81e and 81f are connected to mutually different output parts of the signal processing circuit described above and are each an input terminal to which an output signal (transmission signal) from the output part of the signal processing circuit is input.

The first switch 82 is an antenna switch. The first switch 82 is, for example, a switch integrated circuit (IC). The first switch 82 has a common terminal 82a (first common terminal) and a plurality of (in the example in FIG. 8, two) selection terminals 82b and 82c (a first selection terminal and a second selection terminal). The common terminal 82a is selectively connectable to at least one of the plurality of selection terminals 82b and 82c. The common terminal 82a is connected to the external terminal 81a. The selection terminal 82b is connected to an output part 84b (described later) of the first filter 84. The selection terminal 82c is connected to an input part 86a (described later) of the second filter 86, an output part 87b (described later) of the fourth filter 87, and an input part 88a (described later) of the fifth filter 88.

The second switch 83 is a switch for switching a connection target for an output part 90b (described later) of the first low-noise amplifier 90 to the first signal path M1 or the second signal path M2. The first signal path M1 is a path through which a reception signal in a communication band (for example, n255R) in the non-terrestrial network (NTN) passes. The second signal path M2 is a path through which a reception signal in any of communication bands (such as Band 75, Band 76, Band 32, and GNSS (L1)) in the terrestrial network (TN) passes. The second switch 83 is, for example, a switch integrated circuit (IC). The second switch 83 has a common terminal 83a (second common terminal) and a plurality of (in the example in FIG. 8, two) selection terminals 83b and 83c (a third selection terminal and a fourth selection terminal). The common terminal 83a is connected to an output part 86b of the second filter 86 with the first low-noise amplifier 90 interposed therebetween. The common terminal 83a is thus connected to the output part 90b (described later) of the first low-noise amplifier 90. The selection terminal 83b is connected to the external terminal 81c with the first signal path M1 interposed therebetween. On the first signal path M1, the second low-noise amplifier 91 and the third filter 89 are connected. The selection terminal 83b is thus connected to an input part 91a (described later) of the second low-noise amplifier 91. The selection terminal 83c is connected to the external terminal 81b with the second signal path M2 interposed therebetween.

The first filter 84 is a transmission filter having a first passband including a transmission band of a first communication band. The first communication band is a communication band in the non-terrestrial network, for example, n255. The first passband of the first filter 84 thus includes the transmission band of n255 (hereinafter, described as n255T on occasions). The transmission band of n255 ranges from 1626.5 MHz to 1660.5 MHz.

The first filter 84 has an input part 84a and the output part 84b. The input part 84a is connected to an output part 93b (described later) of a first power amplifier 93. The output part 84b is connected to the selection terminal 82b of the first switch 82. The first filter 84 receives a signal (transmission signal) from the input part 84a, limits the received signal to a signal in the transmission band of the first communication band, allows the limited signal to pass therethrough, and outputs the signal allowed to pass therethrough from the output part 84b.

The second filter 86, the fourth filter 87, and the fifth filter 88 form a triplexer 85. The input part 86a (described later) of the second filter 86, the output part 87b (described later) of the fourth filter 87, and the input part 88a (described later) of the fifth filter 88 form a common input/output part.

The second filter 86 is a reception filter having a second passband including a reception band of the first communication band (n255), a reception band of the second communication band, and a bandwidth of a third communication band. Hereinafter, the reception band of the first communication band (n255) is described as n255R on occasions. The second communication band is the communication band in the terrestrial network, for example, at least one of Band 75, Band 76, or Band 32. Hereinafter, at least one of Band 75, Band 76, or Band 32 is described as Band 75/Band 76/Band 32 on occasions. The third communication band is a predetermined band (for example, the L1 band) of, for example, a global navigation satellite system (GNSS). The GNSS is a general term of systems for measuring a current location on the earth by using artificial satellites and includes a communication band of a global positioning system (GPS). The second passband of the second filter 86 thus includes the reception band of n255 (n255R), the reception band of Band 75/Band 76/Band 32, and the bandwidth of GNSS (L1). The reception band of n255 ranges from 1525 MHz to 1559 MHz. Band 75 ranges from 1432 MHz to 1517 MHz. Band 76 ranges from 1427 MHz to 1432 MHz. Band 32 ranges from 1452 MHz to 1496 MHz. For the bandwidth of GNSS (L1), GLONASS (L1) ranges from 1597.5515 MHz to 1605.886 MHz, and COMPASS (L1) ranges from 1559.052 MHz to 1563.144 MHz. The bandwidth of GPS (L1) ranges from 1574.397 MHz to 1576.442 MHz.

The second filter 86 has the input part 86a and the output part 86b. The input part 86a is connected to the selection terminal 82c of the first switch 82. The output part 86b is connected to an input part 90a (described later) of the first low-noise amplifier 90. The second filter 86 receives a signal (reception signal) from the input part 86a, limits the received signal to a signal in the second passband of the second filter 86, allows the limited signal to pass therethrough, and outputs the signal allowed to pass therethrough from the output part 86b.

The fourth filter 87 is a transmission filter having a fourth passband including a transmission band of a fourth communication band and a transmission band of a fifth communication band. The fourth communication band is a communication band in the non-terrestrial network, for example, n256. The fifth communication band is a communication band in the terrestrial network, for example, Band 1. The fourth passband of the fourth filter 87 thus includes the transmission band of n256 and the transmission band of Band 1. Hereinafter, on occasions, the transmission band of n256 is described as n256T, and the transmission band of Band 1 is described as B1T. The transmission band of n256 ranges from 1980 MHz to 2010 MHz. The transmission band of Band 1 ranges from 1920 MHz to 1980 MHz.

The fourth filter 87 has an input part 87a and the output part 87b. The input part 87a is connected to an output part 94b of a second power amplifier 94. The output part 87b is connected to the selection terminal 82c of the first switch 82. The fourth filter 87 receives a signal (transmission signal) from the input part 87a, limits the received signal to a signal in the fourth passband of the fourth filter 87, allows the limited signal to pass therethrough, and outputs the signal allowed to pass therethrough from the output part 87b.

The fifth filter 88 is a reception filter having a fifth passband including a reception band of the fourth communication band (n256) and a reception band of the fifth communication band (Band 1). Hereinafter, on occasions, the reception band of n256 is described as n256R, and the reception band of Band 1 is described as B1R. The fifth passband of the fifth filter 88 thus includes the reception band of n256 (n256R) and the reception band of Band 1 (B1R). The reception band of n256 ranges from 2170 MHz to 2200 MHz. The reception band of Band 1 ranges from 2110 MHz to 2140 MHz.

The fifth filter 88 has the input part 88a and an output part 88b. The input part 88a is connected to the selection terminal 82c of the first switch 82. The output part 88b is connected to an input part 92a of the third low-noise amplifier 92. The fifth filter 88 receives a signal (reception signal) from the input part 88a, limits the received signal to a signal in the fifth passband of the fifth filter 88, allows the limited signal to pass therethrough, and outputs the signal allowed to pass therethrough from the output part 88b.

The third filter 89 is a filter having a third passband that includes the bandwidth of the third communication band (GNSS (L1)) and that does not include bandwidths of communication bands other than the third communication band (for example, the bandwidths of the first, second, fourth, and fifth communication bands), and is, for example, a band pass filter. The third filter 89 is a filter for removing an unwanted signal (for example, a signal in any of the first, second, fourth, and fifth communication bands) that is not satisfactorily removed by the second filter 86 at the time of communication (for example, at the time of reception) using GNSS (L1). The third filter 89 has an input part 89a and an output part 89b. The third filter 89 receives a signal (reception signal) from the input part 89a, limits the received signal to a signal in the third passband of the third filter 89, allows the limited signal to pass therethrough, and outputs the signal allowed to pass therethrough from the output part 89b.

The first low-noise amplifier 90 is provided between the output part 86b of the second filter 86 and the common terminal 83a of the second switch 83. The first low-noise amplifier 90 is a low-noise amplifier capable of amplifying a signal with a wide bandwidth including the reception band of n255, the reception band of Band 75/Band 76/Band 32, and the bandwidth of GNSS (L1). The first low-noise amplifier 90 has the input part 90a and the output part 90b. The input part 90a is connected to the output part 86b of the second filter 86. The output part 90b is connected to the common terminal 83a of the second switch 83. The first low-noise amplifier 90 amplifies a signal (reception signal) input to the input part 90a and outputs the amplified signal from the output part 90b.

The second low-noise amplifier 91 is provided between the selection terminal 83b of the second switch 83 and the input part 89a of the third filter 89. The second low-noise amplifier 91 is a low-noise amplifier that supports the bandwidth of GNSS (L1) (that is, a low-noise amplifier for GNSS). The second low-noise amplifier 91 is an amplifier for amplifying a shortfall in amplifying the reception signal in GNSS (L1) by the first low-noise amplifier 90. The second low-noise amplifier 91 has the input part 91a and an output part 91b. The input part 91a is connected to the selection terminal 83b of the second switch 83. The output part 91b is connected to the input part 89a of the third filter 89. The second low-noise amplifier 91 amplifies the signal (reception signal) input to the input part 91a and outputs the amplified signal from the output part 91b.

The third low-noise amplifier 92 is provided between the output part 88b of the fifth filter 88 and the external terminal 81d. The third low-noise amplifier 92 is a low-noise amplifier that supports the reception band of n255 (n255R) and the reception band of Band 1 (B1R). The third low-noise amplifier 92 has the input part 92a and an output part 92b. The input part 92a is connected to the output part 88b of the fifth filter 88. The output part 92b is connected to the external terminal 81d. The third low-noise amplifier 92 amplifies a signal (reception signal) input to the input part 92a and outputs the amplified signal from the output part 92b.

The first power amplifier 93 is provided between the external terminal 81f and the input part 84a of the first filter 84. The first power amplifier 93 is a power amplifier that supports the transmission band of the first communication band (n255T). The first power amplifier 93 has an input part 93a and the output part 93b. The input part 93a is connected to the external terminal 81f. The output part 93b is connected to the input part 84a of the first filter 84. The first power amplifier 93 amplifies a signal (transmission signal) input to the input part 93a and outputs the amplified signal from the output part 93b.

The second power amplifier 94 is provided between the external terminal 81e and the input part 87a of the fourth filter 87. The second power amplifier 94 is a power amplifier that supports the transmission band of the fourth communication band (n256T) and the transmission band of the fifth communication band (B1T). The second power amplifier 94 has an input part 94a and the output part 94b. The input part 94a is connected to the external terminal 81e. The output part 94b is connected to the input part 87a of the fourth filter 87. The second power amplifier 94 amplifies a signal (transmission signal) input to the input part 94a and outputs the amplified signal from the output part 94b.

### (2) Passband of Triplexer 85

The reception band of n255 (n255R) is close to the reception bands in Band 75, Band 76, and Band 32. Accordingly, in the second filter 86, the reception bands in Band 75, Band 76, and Band 32 are extended, n255R is included in the extended reception bands, and thereby the reception bands of n255R, Band 75, Band 76, and Band 32 are integrated into one reception band.

Further, the bandwidth of GNSS (L1) is close to the one reception band described above. Accordingly, in the second filter 86, the one reception band described above is extended, the reception band of GNSS (L1) is included in the extended reception band, and thereby the reception band of GNSS (L1) and the one reception band described above are integrated into one reception band. In the second filter 86, the reception band of n255R, Band 75, Band 76, and Band 32, and the bandwidth of GNSS (L1) are thus integrated into the one reception band.

The transmission band of n256 (n256T) is close to the transmission band of Band 1 (B1T). Accordingly, in the fourth filter 87, the transmission band of Band 1 (B1T) is extended, n256T is included in the extended transmission band, and thereby n256T and B1T are integrated into one transmission band.

The reception band of n256 (n256R) is close to the reception band of Band 1 (B1R). Accordingly, in the fifth filter 88, the reception band of Band 1 (B1R) is extended, n256R is included in the extended reception band, and thereby n256R and B1R are integrated into one reception band.

The reception band of the second filter 86, the transmission band of the fourth filter 87, and the reception band of the fifth filter 88 are close to each other. Accordingly, the reception band of the second filter 86, the transmission band of the fourth filter 87, and the reception band of the fifth filter 88 are integrated into the one passband, and thereby the triplexer 85 is formed.

The transmission band of n255 (n255T) is not close to the bandwidths of the different communication bands (the transmission bands in Band 75, Band 76, and Band 32, B1T, and B1R). Accordingly, the transmission band of the first filter 84 having the first passband including n255T is difficult to be included in the passband of the triplexer 85 to form the one filter. Accordingly, the first filter 84 is formed as an independent filter isolated from the triplexer 85.

### (3) Operations

Example operations of the radio frequency module 1 according to Embodiment 5 will be described with reference to FIG. 8.

### (3-1) Operations in Transmitting Transmission Signal in n255T

In the first switch 82, the common terminal 82a is connected to the selection terminal 82b. In this state, a transmission signal is input from the signal processing circuit (illustration omitted) to the external terminal 81f. The transmission signal input to the external terminal 81f then passes through the first power amplifier 93, the first filter 84, and the first switch 82 and is transmitted from the antenna 3.

### (3-2) Operations in Transmitting Transmission Signal in n256T or Transmission Signal in B1T

In the first switch 82, the common terminal 82a is connected to the selection terminal 82c. In this state, a transmission signal is input from the signal processing circuit (illustration omitted) to the external terminal 81e. The transmission signal input to the external terminal 81e then passes through the second power amplifier 94, the fourth filter 87, and the first switch 82 and is transmitted from the antenna 3.

### (3-3) Operations in Receiving Reception Signal in n256R or Reception Signal in B1R

In the first switch 82, the common terminal 82a is connected to the selection terminal 82c. In response to the antenna 3 receiving a reception signal in n256R or a reception signal in B1R in this state, the reception signal passes through the antenna 3, the first switch 82, the fifth filter 88, and the third low-noise amplifier 92 and is output from the external terminal 81d to the signal processing circuit (illustration omitted).

### (3-4) Operations in Receiving Reception Signal in GNSS (L1)

In the first switch 82, the common terminal 82a is connected to the selection terminal 82c. In the second switch 83, the common terminal 83a is connected to the selection terminal 83b. In response to the antenna 3 receiving a reception signal in GNSS (L1) in this state, the reception signal passes through the antenna 3, the first switch 82, the second filter 86, the first low-noise amplifier 90, the second switch 83, the second low-noise amplifier 91, and the third filter 89 and is output from the external terminal 81c to the signal processing circuit (illustration omitted). At this time, the reception signal passes through the second filter 86 having the relatively wide second passband and thereafter passes through the third filter 89 for GNSS. An unwanted signal (a signal in a band other than GNSS (L1)) that has not been sufficiently removed by the second filter 86 is thereby sufficiently removed by the third filter 89. In addition, the reception signal is amplified by the first low-noise amplifier 90 that supports a relatively wide bandwidth and thereafter is further amplified by the second low-noise amplifier 91 for GNSS (L1). A shortfall in amplifying the reception signal by the first low-noise amplifier 90 is thereby compensated for by the amplification of the reception signal by the second low-noise amplifier 91.

### (3-5) Operations in Receiving Reception Signal in n255R or Reception Signal in Band 75/Band 76/Band 32

In the first switch 82, the common terminal 82a is connected to the selection terminal 82c. In the second switch 83, the common terminal 83a is connected to the selection terminal 83c. In response to the antenna 3 receiving a reception signal in n255R or a reception signal in Band 75/Band 76/Band 32 in this state, the reception signal passes through the antenna 3, the first switch 82, the second filter 86, the first low-noise amplifier 90, and the second switch 83 and is output from the external terminal 81b to the signal processing circuit (illustration omitted).

### (3-6) Simultaneous Communication

In the example operations described above, the case where transmission or reception alone in one of the first to fifth communication bands is performed is exemplified. However, the communication may be performed simultaneously by using two or more communication bands of the first to fifth communication bands.

For example, reception using GNSS (L1) and transmission using n255T may be performed simultaneously. In this case, a reception signal in GNSS received at the antenna 3 passes through the first switch 82, the second filter 86, the first low-noise amplifier 90, the second switch 83, the second low-noise amplifier 91, and the third filter 89 and is output from the external terminal 81c. At this time, the transmission signal in n255T enters the second filter 86 from the first filter 84 via the first switch 82, passes through the first low-noise amplifier 90 and the second switch 83, and enters the first signal path M1 serving as the signal path for GNSS on occasions. In this case, the transmission signal having entered the first signal path M1 is removed by the third filter 89. Accordingly, the reception signal in GNSS is output from the external terminal 81c without being contaminated with the transmission signal described above.

Reception using GNSS (L1) and transmission using n256T or B1T may be performed simultaneously. Also in this case, a reception signal in GNSS received at the antenna 3 passes through the first switch 82, the second filter 86, the first low-noise amplifier 90, the second switch 83, the second low-noise amplifier 91, and the third filter 89 and is output from the external terminal 81c. At this time, the transmission signal in n256T or B1T enters the second filter 86 from the fourth filter 87 via the triplexer 85, passes through the first low-noise amplifier 90 and the second switch 83, and enters the first signal path M1 serving as the signal path for GNSS on occasions. Also in this case, the transmission signal having entered the first signal path M1 is removed by the third filter 89. Accordingly, the reception signal in GNSS is output from the external terminal 81c without being contaminated with the transmission signal described above.

### (4) Third Filter Location

As illustrated in FIG. 8, the third filter 89 is connected between the second low-noise amplifier 91 and the external terminal 81c. The third filter 89 is thus disposed downstream of the first low-noise amplifier 90 and the second low-noise amplifier 91. The third filter 89 thereby attenuates the reception signal after the amplification by the first low-noise amplifier 90 and the second low-noise amplifier 91 (that is, after the amplification by all of the low-noise amplifiers), and thus the reception signal may be attenuated effectively. The third filter 89 may thus remove an unwanted signal included in the reception signal effectively.

### (5) Features and Operation

The radio frequency module 1 according to Embodiment 5 includes the external terminal 81a (antenna terminal), the first switch 82, the first filter 84, and the second filter 86. The first switch 82 has the common terminal 82a (first common terminal), the selection terminal 82b (first selection terminal), and the selection terminal 82c (second selection terminal). The common terminal 82a is connected to the external terminal 81a. The selection terminal 82b and the selection terminal 82c are connectable to the common terminal 82a. The first filter 84 is connected to the selection terminal 82b. The second filter 86 is connected to the selection terminal 82c. The first passband of the first filter 84 includes the transmission band of the first communication band (n255) serving as a communication band in the non-terrestrial network. The second passband of the second filter 86 includes the reception band of the first communication band and the reception band of the second communication band (Band 75/Band 76/Band 32). The second communication band is the communication band in the terrestrial network.

With this configuration, the second filter 86 doubly serves as the reception filter for the first communication band and the reception filter for the second communication band, and thus cost reduction and compactness of the radio frequency module 1 may be achieved.

In the radio frequency module 1 according to Embodiment 5, the second passband of the second filter 86 includes the bandwidth of the third communication band serving as the GNSS communication band. With this configuration, the second filter 86 further doubly serves as the reception filter for the third communication band, and thus further cost reduction and compactness of the radio frequency module 1 may be achieved.

The radio frequency module 1 according to Embodiment 5 includes the external terminal 81c (first output terminal), the external terminal 81b (second output terminal), the second switch 83, the first low-noise amplifier 90, the second low-noise amplifier 91, and the third filter 89. The second switch 83 has the common terminal 83a (second common terminal), the selection terminal 83b (third selection terminal), and the selection terminal 83c (fourth selection terminal). The common terminal 83a is connected to the second filter 86. The selection terminal 83b is connected to the external terminal 81c. The selection terminal 83c is connected to the external terminal 81b. The first low-noise amplifier 90 is connected between the second filter 86 and the common terminal 83a of the second switch 83. The second low-noise amplifier 91 is connected between the selection terminal 83b and the external terminal 81c. The third filter 89 is connected between the second low-noise amplifier 91 and the external terminal 81c. The third passband of the third filter 89 includes the bandwidth of the third communication band (GNSS (L1)) and does not include the bandwidths (n255R and n255T) of the first communication band (n255).

With this configuration, an unwanted signal (for example, the transmission signal in n255T) having entered the first signal path M1 for the third communication band at the time of communication (for example, at the time of reception) using the third communication band may be removed by the third filter 89. The third filter 89 is disposed downstream of the first low-noise amplifier 90 and the second low-noise amplifier 91, and thus the third filter 89 may remove the signal (unwanted signal) after the amplification by the first low-noise amplifier 90 and the second low-noise amplifier 91. The third filter 89 may thereby remove the unwanted signal wave described above effectively.

In the radio frequency module 1 according to Embodiment 5, the first communication band is n255, and the second communication band is one or more of Band 75, Band 76, and Band 32. With this configuration, the actions and effects described above may be exerted in the case where the first communication band is n255 and the second communication band is one or more of Band 75, Band 76, and Band 32.

The radio frequency module 1 according to Embodiment 5 includes the fourth filter 87 and the fifth filter 88. The fourth filter 87 is connected to the selection terminal 82c (second selection terminal). The fifth filter 88 is connected to the selection terminal 82c (second selection terminal). The fourth passband of the fourth filter 87 includes the transmission band (n256T) of the fourth communication band (n256) serving as a communication band in the non-terrestrial network. The fifth passband of the fifth filter 88 includes the reception band of the fourth communication band (n256R).

With this configuration, the second filter 86, the fourth filter 87, and the fifth filter 88 are connected to the selection terminal 82c of the first switch 82 and may thus be integrated as the triplexer 85. Further cost reduction and compactness of the radio frequency module 1 may thereby be achieved.

In the radio frequency module 1 according to Embodiment 5, the fourth passband of the fourth filter 87 includes the transmission band (B1T) of the fifth communication band (Band 1) serving as a communication band in the terrestrial network. The fifth passband of the fifth filter 88 includes the reception band of the fifth communication band (B1R).

With this configuration, the fourth filter 87 doubly serves as the transmission filter for the fourth communication band and the transmission filter for the fifth communication band, and thus cost reduction and compactness of the radio frequency module 1 may be achieved. The fifth filter 88 doubly serves as the reception filter for the fourth communication band and the reception filter for the fifth communication band, and thus further cost reduction and compactness of the radio frequency module 1 may be achieved.

### (6) Modifications

Modifications of Embodiment 5 will be described. Hereinafter, description of the same configuration as that in Embodiment 5 is omitted, and a configuration different from that in Embodiment 5 is mainly described on occasions.

### (6-1) Modification 1

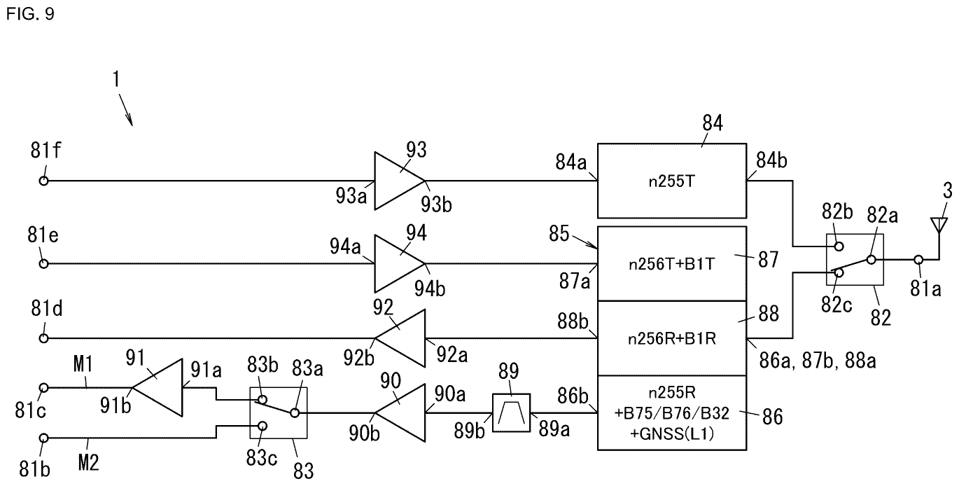

In Embodiment 5, the case where the third filter 89 is connected between the second low-noise amplifier 91 and the external terminal 81c (see FIG. 8) has been exemplified. In contrast, in Modification 1, as illustrated in FIG. 9, the third filter 89 is connected between the output part 86b of the second filter 86 and the input part 90a of the first low-noise amplifier 90. According to Modification 1, an unwanted signal (for example, the transmission signal in n255T) having entered the first signal path M1 for the third communication band at the time of communication (for example, at the time of reception) using the third communication band (GNSS) may be removed by the third filter 89. The third filter 89 is disposed between the second filter 86 and the first low-noise amplifier 90, and thus input of the unwanted signal to the first low-noise amplifier 90 and the second low-noise amplifier 91 may be reduced by using the third filter 89. Deterioration in the characteristics of the first low-noise amplifier 90 and the second low-noise amplifier 91 due to the unwanted signal may thereby be reduced.

### (6-2) Modification 2

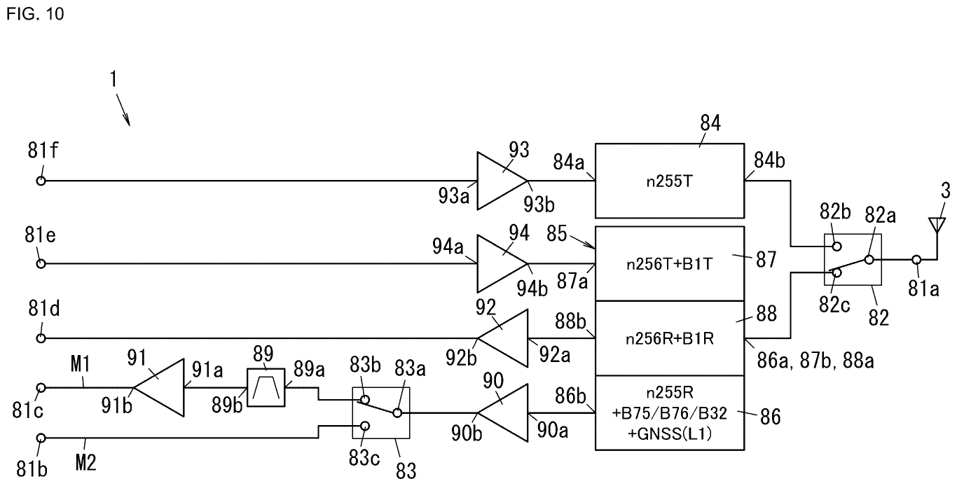

In Embodiment 5, the case where the third filter 89 is connected between the second low-noise amplifier 91 and the external terminal 81c (see FIG. 8) has been exemplified. In contrast, in Modification 2, as illustrated in FIG. 10, the third filter 89 is connected between the input part 91a of the second low-noise amplifier 91 and the selection terminal 83b of the second switch 83. According to Modification 2, the third filter 89 is disposed upstream of the second low-noise amplifier 91. Accordingly, by using the third filter 89, input of the unwanted signal to the second low-noise amplifier 91 may be reduced, and deterioration in the characteristics of the second low-noise amplifier 91 due to the unwanted signal described above may be reduced. The third filter 89 is disposed downstream of the first low-noise amplifier 90. Accordingly, the third filter 89 attenuates the reception signal after the amplification by the first low-noise amplifier 90, and thus the reception signal may be attenuated effectively. The unwanted signal may thus be removed effectively.

### (6-3) Modification 3

In Embodiment 5, the case where the second filter 86, the fourth filter 87, and the fifth filter 88 form the triplexer 85 has been exemplified. However, the fourth filter 87 and the fifth filter 88 may form a duplexer, and the second filter 86 may form an independent reception filter. In Modification 3, the second filter 86 is isolated from the duplexer described above. Accordingly, as compared with the case where the second filter 86 and the duplexer described above are integrated as the triplexer 85, insertion loss of the filters attributed to the filter deterioration due to the integration may be reduced.

### Embodiment 6

### (1) Configuration

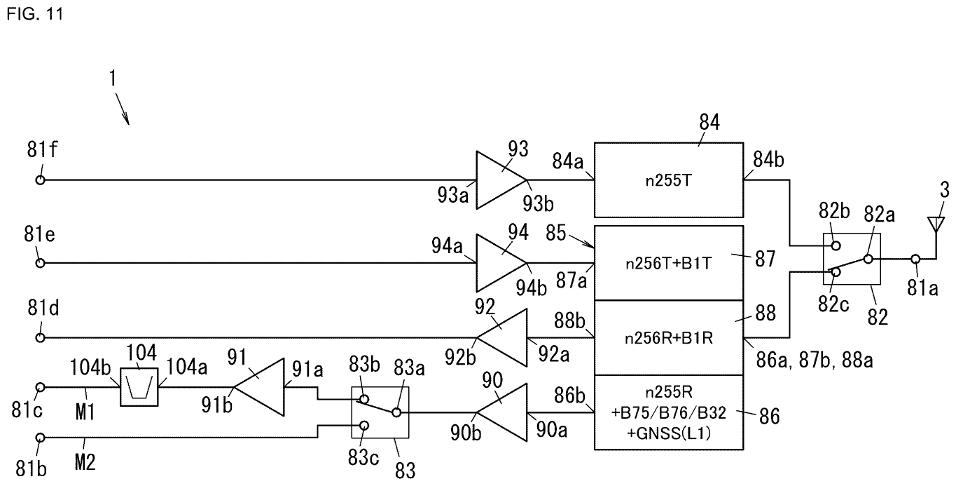

A radio frequency module 1 according to Embodiment 6 will be described with reference to FIG. 11. Hereinafter, description of the same configuration as that in Embodiment 5 is omitted, and a configuration different from that in Embodiment 5 is mainly described on occasions.

As illustrated in FIG. 11, the radio frequency module 1 according to Embodiment 6 is configured similarly to the radio frequency module 1 according to Embodiment 1 except that the third filter 89 (see FIG. 8) is replaced with a band rejection filter 104.

The band rejection filter 104 is a filter capable of attenuating a signal in only a specific band. The band rejection filter 104 has a stop band including only the specific band. The specific band described above includes the transmission band (n256T) of the fourth communication band (n256) and the transmission band of Band 1 (B1T). The band rejection filter 104 is connected between the external terminal 81c and the output part 91b of the second low-noise amplifier 91. In more detail, the band rejection filter 104 has an input part 104a and an output part 104b. The input part 104a is connected to the output part 91b of the second low-noise amplifier 91. The output part 104b is connected to the external terminal 81c. The band rejection filter 104 attenuates a signal in a specific band of signals (reception signals) input to the input part 104a and outputs a signal in a band other than the specific band from the output part 104b.

### (2) Operations

Operations in simultaneously receiving a reception signal in GNSS (L1) and transmitting a transmission signal in n256T or B1T will be described as an example with reference to FIG. 11.

In the first switch 82, the common terminal 82a is connected to the selection terminal 82c. In the second switch 83, the common terminal 83a is connected to the selection terminal 83b. In response to the antenna 3 receiving the reception signal in GNSS (L1) in this state, the reception signal passes through the antenna 3, the first switch 82, the second filter 86, the first low-noise amplifier 90, the second switch 83, the second low-noise amplifier 91, and the band rejection filter 104 and is output from the external terminal 81c to the signal processing circuit (illustration omitted). In response to the transmission signal being input from the signal processing circuit described above to the external terminal 81e in parallel to the reception, the transmission signal passes through the fourth filter 87 and the first switch 82 and is transmitted from the antenna 3. At this time, part of the transmission signal having passed through the fourth filter 87 enters the second filter 86 via the triplexer 85, and thereby the transmission signal described above contaminates the reception signal described above on occasions. In this case, when the reception signal described above contaminated with the transmission signal described above passes through the band rejection filter 104, the transmission signal described above in the reception signal described above is removed by the band rejection filter 104. As described above, even if the reception of the reception signal in GNSS (L1) and the transmission of the transmission signal in n255T or B1T are performed simultaneously, the contamination of the reception signal in GNSS (L1) with the transmission signal in n255T or B1T as the unwanted signal may be reduced.

### (3) Features and Operation

The radio frequency module 1 according to Embodiment 6 includes the band rejection filter 104 between the external terminal 81c and the second low-noise amplifier 91. The stop band of the band rejection filter 104 includes the transmission band (n256T) of the fourth communication band (n256) and the transmission band (B1T) of Band 1. Accordingly, even if the reception using the third communication band (GNSS) and the transmission using the fourth communication band (n256) or the fifth communication band (Band 1) is performed simultaneously, the contamination of the reception signal in the third communication band with the transmission signal in the fourth communication band or the fifth communication band may be reduced.

### (4) Modifications

Modifications of Embodiment 6 will be described. Hereinafter, description of the same configuration as that in Embodiment 6 is omitted, and a configuration different from that in Embodiment 6 is mainly described on occasions.

### (4-1) Modification 1

In Embodiment 6, the case where the band rejection filter 104 is connected between the second low-noise amplifier 91 and the external terminal 81c has been exemplified. However, the band rejection filter 104 may be connected between the output part 86b of the second filter 86 and the common terminal 83a of the second switch 83, like the third filter 89 illustrated in FIG. 9. In this case, the band rejection filter 104 is disposed upstream of the first low-noise amplifier 90 and the second low-noise amplifier 91. The band rejection filter 104 removes an unwanted signal from the reception signal, and thereby input of the unwanted signal to the first low-noise amplifier 90 and the second low-noise amplifier 91 may be reduced. As a result, deterioration in the characteristics of the first low-noise amplifier 90 and the second low-noise amplifier 91 due to the unwanted signal described above may thereby be reduced.

### (4-2) Modification 2

In Embodiment 6, the case where the band rejection filter 104 is connected between the second low-noise amplifier 91 and the external terminal 81c has been exemplified. However, the band rejection filter 104 may be connected between the input part 91a of the second low-noise amplifier 91 and the selection terminal 83b of the second switch 83, like the third filter 89 illustrated in FIG. 10. In this case, the band rejection filter 104 is disposed upstream of the second low-noise amplifier 91. Accordingly, by using the band rejection filter 104, input of the unwanted signal to the second low-noise amplifier 91 may be reduced, and deterioration in the characteristics of the second low-noise amplifier 91 due to the unwanted signal described above may be reduced. The band rejection filter 104 is also disposed downstream of the first low-noise amplifier 90. For this reason, the band rejection filter 104 attenuates the reception signal after the amplification by the first low-noise amplifier 90, and thus the reception signal may be attenuated effectively. The unwanted signal may thus be removed effectively.

### Embodiment 7

### (1) Configuration

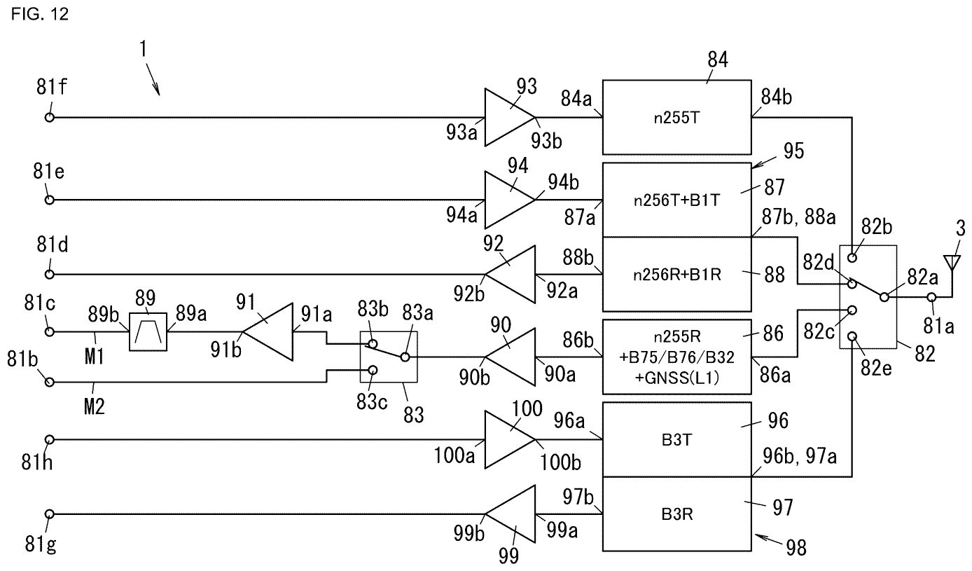

A radio frequency module 1 according to Embodiment 7 will be described with reference to FIG. 12. Hereinafter, description of the same configuration as that in Embodiment 5 is omitted, and a configuration different from that in Embodiment 5 is mainly described on occasions.

As illustrated in FIG. 12, the radio frequency module 1 according to Embodiment 7 is configured similarly to the radio frequency module 1 according to Embodiment 5 mainly except that the radio frequency module 1 according to Embodiment 7 further includes a sixth filter 96, a seventh filter 97, a fourth low-noise amplifier 99, a third power amplifier 100, and external terminals 81g and 81h. Hereinafter, Embodiment 7 will be described in detail.

The external terminal 81g is connected to the input part of the signal processing circuit (illustration omitted) and is an output terminal that outputs a reception signal processed by the radio frequency module 1 to the input part of the signal processing circuit described above. The external terminal 81h is connected to the output part of the signal processing circuit and is an input terminal to which an output signal (transmission signal) from the output part of the signal processing circuit is input.

The first switch 82 in Embodiment 7 is configured similarly to the first switch 82 in Embodiment 5 except that the first switch 82 in Embodiment 7 further includes selection terminals 82d and 82e. In the first switch 82 in Embodiment 7, the common terminal 82a is selectively connectable to at least one of the plurality of selection terminals 82b to 82e. Connection targets for the common terminal 82a and the selection terminal 82b are the same as those in Embodiment 5. The selection terminal 82c is connected to the input part 86a (described later) of the second filter 86. The selection terminal 82d is connected to the output part 87b (described later) of the fourth filter 87 and the input part 88a (described later) of the fifth filter 88. The selection terminal 82e is connected to an output part 96b (described later) of the sixth filter 96 and an input part 97a (described later) of the seventh filter 97.

The sixth filter 96 and the seventh filter 97 form a diplexer 98. The output part 96b (described later) of the sixth filter 96 and the input part 97a (described later) of the seventh filter 97 form a common input/output part and are connected to the selection terminal 82e of the first switch 82.

The sixth filter 96 is a transmission filter having the sixth passband including the transmission band of the sixth communication band. The sixth communication band is a communication band in the terrestrial network, for example, Band 3. The sixth passband of the sixth filter 96 thus includes a transmission band of Band 3 (hereinafter, described as B3T on occasions). The sixth filter 96 has an input part 96a and the output part 96b. The input part 96a is connected to an output part 100b (described later) of the third power amplifier 100. The output part 96b is connected to the selection terminal 82e of the first switch 82. The sixth filter 96 receives a signal (transmission signal) from the input part 96a, limits the received signal to a signal in the transmission band of the sixth communication band, allows the limited signal to pass therethrough, and outputs the signal allowed to pass therethrough from the output part 96b.

The seventh filter 97 is a reception filter having a seventh passband including the reception band of the sixth communication band (Band 3) (hereinafter, described as B3R on occasions). The seventh filter 97 has the input part 97a and an output part 97b. The input part 97a is connected to the selection terminal 82e of the first switch 82. The output part 97b is connected to an input part 99a (described later) of the fourth low-noise amplifier 99. The seventh filter 97 receives a signal (reception signal) from the input part 97a, limits the received signal to a signal in the reception band of the sixth communication band, allows the limited signal to pass therethrough, and outputs the signal allowed to pass therethrough from the output part 97b.

The fourth low-noise amplifier 99 is provided between the output part 97b of the seventh filter 97 and the external terminal 81g. The fourth low-noise amplifier 99 is a low-noise amplifier that supports the reception band (B3R) of the sixth communication band (Band 3). The fourth low-noise amplifier 99 has the input part 99a and an output part 99b. The input part 99a is connected to the output part 97b of the seventh filter 97. The output part 99b is connected to the external terminal 81g. The fourth low-noise amplifier 99 amplifies a signal (reception signal) input to the input part 99a and outputs the amplified signal from the output part 99b.

The third power amplifier 100 is provided between the external terminal 81h and the input part 96a of the sixth filter 96. The third power amplifier 100 is a power amplifier that supports the transmission band (B3T) of the sixth communication band (Band 3). The third power amplifier 100 has an input part 100a and the output part 100b. The input part 100a is connected to the external terminal 81h. The output part 100b is connected to the input part 96a of the sixth filter 96. The third power amplifier 100 amplifies a signal (transmission signal) input to the input part 100a and outputs the amplified signal from the output part 100b.

The fourth filter 87 and the fifth filter 88 in Embodiment 7 are configured similarly to the fourth filter 87 and the fifth filter 88 in Embodiment 5 except that the fourth filter 87 and the fifth filter 88 in Embodiment 7 form a duplexer 95. The output part 87b of the fourth filter 87 and the input part 88a of the fifth filter 88 in Embodiment 7 form a common input/output part and are connected to the selection terminal 82d of the first switch 82.

The second filter 86 in Embodiment 7 is configured similarly to the second filter 86 in Embodiment 5 except that the second filter 86 is formed as an independent filter. The input part 86a of the second filter 86 in Embodiment 7 is connected to the selection terminal 82c of the first switch 82.

### (2) Features and Operation

The radio frequency module 1 according to Embodiment 7 includes the sixth filter 96 and the seventh filter 97, and transmission and reception using the sixth communication band (Band 3) may thus be performed.

In Embodiment 7, the second filter 86 is isolated from the duplexer 95, and thus insertion loss of the filters attributed to the filter deterioration due to the integration may be reduced as compared with the case where the second filter 86 and the duplexer 95 are integrated to serve as the triplexer.

### Embodiment 8

### (1) Configuration

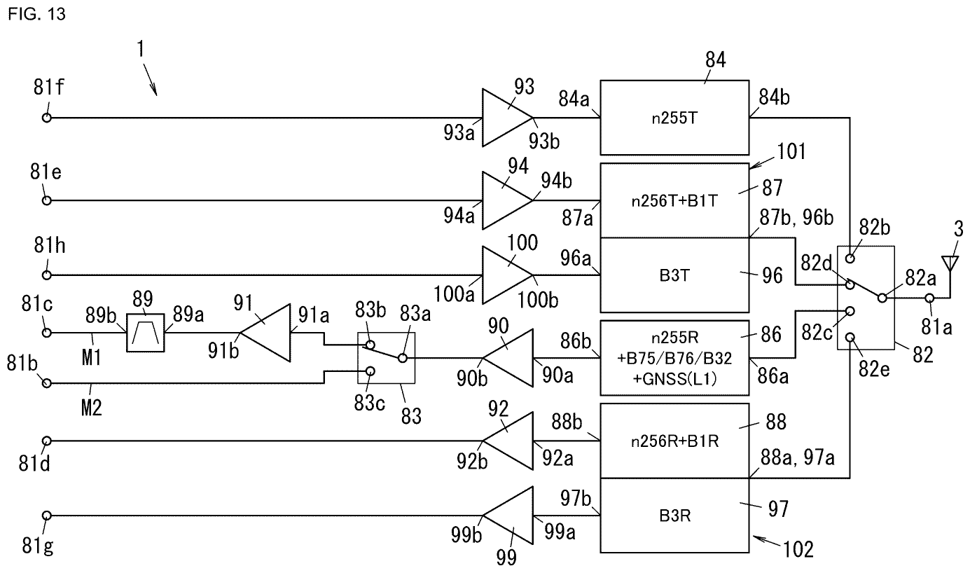

A radio frequency module 1 according to Embodiment 8 will be described with reference to FIG. 13. Hereinafter, description of the same configuration as that in Embodiment 7 is omitted, and a configuration different from that in Embodiment 7 is mainly described on occasions.

As illustrated in FIG. 13, the radio frequency module 1 according to Embodiment 8 is configured similarly to the radio frequency module 1 according to Embodiment 7 mainly except that the locations of the fifth filter 88 and the sixth filter 96 are replaced with those in the radio frequency module 1 according to Embodiment 7. Hereinafter, Embodiment 8 will be described in detail.

In Embodiment 8, the fourth filter 87 (transmission filter) and the sixth filter 96 (transmission filter) are integrated to form a duplexer 101. The two transmission filters (the fourth filter 87 and the sixth filter 96) are thus integrated into one filter (the duplexer 101). The output part 87b of the fourth filter 87 and the output part 96b of the sixth filter 96 form a common output part and are connected to the selection terminal 82d of the first switch 82.

In Embodiment 8, the fifth filter 88 (reception filter) and the seventh filter 97 (reception filter) are integrated to form a duplexer 102. The two reception filters (the fifth filter 88 and the seventh filter 97) are thus integrated into one filter (the duplexer 102). The input part 88a of the fifth filter 88 and the input part 97a of the seventh filter 97 form a common output part and are connected to the selection terminal 82e of the first switch 82.

(2) Features and Operation The radio frequency module 1 according to Embodiment 8 includes the fourth filter 87 and the fifth filter 88. The first switch 82 further has the selection terminal 82d (third selection terminal) and the selection terminal 82e (fourth selection terminal). The selection terminal 82d is connected to the fourth filter 87. The selection terminal 82e is connected to the fifth filter 88. The fourth passband of the fourth filter 87 includes the transmission band (n256T) of the fourth communication band (n256) serving as a communication band in the non-terrestrial network. The fifth passband of the fifth filter 88 includes the reception band of the fourth communication band (n256R). With this configuration, the radio frequency module 1 includes the fourth filter 87 and the fifth filter 88, and transmission and reception in the fourth communication band may thus be performed.

In the radio frequency module 1 according to Embodiment 8, the fourth passband of the fourth filter 87 includes the transmission band (B1T) of the fifth communication band (Band 1) serving as a communication band in the terrestrial network. The fifth passband of the fifth filter 88 includes the reception band of the fifth communication band (B1R).

With this configuration, the fourth filter 87 doubly serves as the transmission filter for the fourth communication band and the transmission filter for the fifth communication band, and thus cost reduction and compactness of the radio frequency module may be achieved. The fifth filter 88 also doubly serves as the reception filter for the fourth communication band and the reception filter for the fifth communication band, and thus cost reduction and compactness of the radio frequency module 1 may be achieved.

In the radio frequency module 1 according to Embodiment 8, the fourth communication band is n256. The fifth communication band is Band 1. With this configuration, the actions and effects described above may be exerted in the case where the fourth communication band is n256 and the fifth communication band is Band 1.

In the radio frequency module 1 according to Embodiment 8, the fourth filter 87 and the sixth filter 96 (that is, the transmission filters) are integrated into the duplexer 101, and the fifth filter 88 and the seventh filter 97 (that is, the reception filters) are integrated into the duplexer 102. Accordingly, the plurality of filters in the radio frequency module 1 may be easily divided into the transmission filters and the reception filters to be disposed. Isolation between the transmission filters and the reception filters in the radio frequency module 1 may thus be ensured easily.

### Embodiment 9

### (1) Configuration

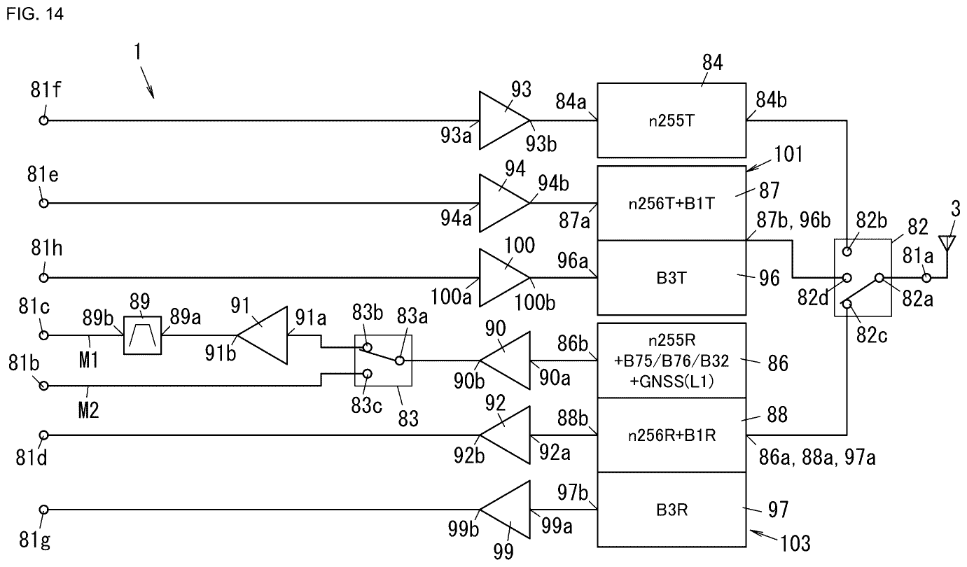

A radio frequency module 1 according to Embodiment 9 will be described with reference to FIG. 14. Hereinafter, description of the same configuration as that in Embodiment 8 is omitted, and a configuration different from that in Embodiment 8 is mainly described on occasions.

As illustrated in FIG. 14, the radio frequency module 1 according to Embodiment 9 is configured similarly to the radio frequency module 1 according to Embodiment 8 except that the second filter 86, the fifth filter 88, and the seventh filter 97 (that is, the three reception filters) form a triplexer 103. Hereinafter, Embodiment 9 will be described in detail.

In Embodiment 9, as described above, the second filter 86, the fifth filter 88, and the seventh filter 97 (that is, three reception filters) form the triplexer 103. The input part 86a of the second filter 86, the input part 88a of the fifth filter 88, and the input part 97a of the seventh filter 97 form a common input part and are connected to the selection terminal 82c of the first switch 82.

### (2) Features and Operation

In the radio frequency module 1 according to Embodiment 9, the second filter 86, the fifth filter 88, and the seventh filter 97 (that is, all of the reception filters in the radio frequency module 1) are integrated by the triplexer 103, and the plurality of filters in the radio frequency module may thus be easily divided into the transmission filters and the reception filters to be disposed. Isolation between the transmission filters and the reception filters in the radio frequency module 1 may thus be ensured easily.

The second filter 86, the fifth filter 88, and the seventh filter 97 (that is, all of the reception filters in the radio frequency module 1) are integrated into one filter (triplexer 103), and the radio frequency module 1 may thus be configured compactly.

### Aspects

This specification discloses the following aspects.

A radio frequency module (1) according to a first aspect includes a switch (6), a first duplexer (11), and at least one or more second duplexers (12 and 13) or one or more filters (14 and 15). The first duplexer (11) is connected to the switch (6). The first duplexer (11) has a transmission filter (11T) and a reception filter (11R). The transmission filter (11T) has a passband including a transmission band of n255. The reception filter (11R) has a passband including a reception band of at least one of Band 75, Band 76, or Band 32 and a reception band of n255.

With this configuration, the reception band of at least one of Band 75, Band 76, or Band 32 (hereinafter, described as Band 75/Band 76/Band 32) and the reception band of n255 may be co-banded by using the reception filter (11R). The term “co-banding” denotes that a plurality of communication bands are included in a passband of one filter. A passband of the reception filter (11R) thus includes the reception band of n255 and the reception band of Band 75/Band 76/Band 32. Accordingly, as compared with a case where a reception filter that supports the reception band of n255 and a reception filter that supports the reception band of Band 75/Band 76/Band 32 are separately provided, the radio frequency module (1) may be configured compactly.

In the first aspect, in the radio frequency module (1) according to a second aspect, the passband of the reception filter (11R) further includes a communication band for GNSS.

With this configuration, as compared with a case where a reception filter that supports the communication band for GNSS is separately provided, the radio frequency module (1) may be configured compactly.

In the second aspect, the radio frequency module (1) according to a third aspect further includes a first low-noise amplifier (20) and a second low-noise amplifier (30). The first low-noise amplifier (20) is connected to the reception filter (11R). The second low-noise amplifier (30) is provided on a first signal path (M1) and amplifies a signal in the communication band for GNSS, the first signal path (M1) and a second signal path (M2) branching downstream of the first low-noise amplifier (20).

With this configuration, each signal in a corresponding one of the plurality of co-banded communication bands (GNSS (L1), n255, Band 75, Band 76, and Band 32) may be amplified by the shared first low-noise amplifier (20). The signal in the communication band for GNSS may be amplified by the second low-noise amplifier (30). Even if the received signal strength of a signal in the communication band for GNSS is lower than the received signal strength of a signal in any of the remaining communication bands (n255, Band 75, Band 76, and Band 32), each signal in a corresponding one of the plurality of co-banded communication bands may thereby be amplified to have a signal strength appropriate for signal processing by the first low-noise amplifier (20) and the second low-noise amplifier (30).

In the second aspect, the radio frequency module (1) according to a fourth aspect includes a low-noise amplifier (20), a demultiplexer (40), and a variable attenuator (41). The low-noise amplifier (20) is connected to the reception filter (11R). The demultiplexer (40) demultiplexes a first signal in the communication band for GNSS that is included in an output signal from the low-noise amplifier (20), outputs the demultiplexed first signal to a first signal path (M1), demultiplexes a second signal in at least one reception band of n255, Band 75, Band 76, or Band 32, and outputs the demultiplexed second signal to a second signal path (M2), the second signal being included in the output signal from the low-noise amplifier (20). The variable attenuator (41) is provided on the second signal path (M2) and attenuates the second signal.

With this configuration, each signal in a corresponding one of the plurality of co-banded communication bands (GNSS (L1), n255, Band 75, Band 76, and Band 32) may be amplified by the shared low-noise amplifier (20). The radio frequency module (1) may thereby be configured compactly. The second signal demultiplexed to the second signal path (M2) by the demultiplexer (40) may be attenuated by the variable attenuator (41). Even if the received signal strength of the signal in the communication band for GNSS is lower than the received signal strength of the signal in any of the remaining communication bands (n255, Band 75, Band 76, and Band 32), each signal in a corresponding one of the plurality of co-banded communication bands may thereby be amplified to have a signal strength appropriate for signal processing.

In the second aspect, the radio frequency module (1) according to a fifth aspect includes a low-noise amplifier (20), a coupler (50), and a variable element (60). The low-noise amplifier (20) is connected to the reception filter (11R). The coupler (50) has a main line (51) and a sub line (52). The main line (51) is connected to the low-noise amplifier (20). The sub line (52) has electromagnetic coupling with the main line (51). The variable element (60) is a variable element provided on the sub line (52) and for controlling a coupling amount of the electromagnetic coupling between the main line (51) and the sub line (52). The coupler (50) demultiplexes a signal in at least one reception band of n255, Band 75, Band 76, or Band 32 from an output signal from the low-noise amplifier (20) that passes through the main line (51), and outputs the demultiplexed signal to the sub line (52).

With this configuration, each signal in a corresponding one of the plurality of co-banded communication bands (GNSS (L1), n255, Band 75, Band 76, and Band 32) may be amplified by the shared low-noise amplifier (20). The radio frequency module (1) may thereby be configured compactly. In addition, the coupling amount of the electromagnetic coupling between the main line (51) and the sub line (52) may be controlled by using the variable element (60).

In the fifth aspect, the radio frequency module (1) according to a sixth aspect further includes a variable attenuator (70). The variable attenuator (70) is provided on the main line (51) and attenuates the output signal from the low-noise amplifier (20) that passes through the main line (51).

With this configuration, an output signal from the reception filter (11R) may be amplified by the low-noise amplifier (20) such that a signal extracted from the sub line (52) (n255, Band 75, Band 76, and Band 32) has a signal strength appropriate for signal processing (for example, demodulation). The output signal from the low-noise amplifier (20) may be attenuated by the variable attenuator (70) such that a signal extracted from the main line (51) (the signal in the communication band for GNSS) has a signal strength appropriate for signal processing. As a result, each signal in a corresponding one of the plurality of co-banded communication bands (GNSS (L1), n255, Band 75, Band 76, and Band 32) may be amplified to have the signal strength appropriate for the signal processing.

A communication apparatus (25) according to a seventh aspect includes the radio frequency module (1) according to any one of the first to sixth aspects and a signal processing circuit (2). The signal processing circuit (2) is connected to the radio frequency module (1) and performs signal processing on a radio frequency signal.

With this configuration, a communication apparatus having one of more of the above features and operations of a radio frequency module may be provided.

### REFERENCE SIGNS LIST

1 radio frequency module
2 signal processing circuit
2a RF signal processing circuit
2b baseband signal processing circuit
3 antenna
5a to 5j external terminal
6 switch
6a common terminal
6b to 6f selection terminal
7 switch
7a common terminal
7b, 7c, 7d selection terminal
8 switch
8a to 8c common terminal
8d, 8e selection terminal
9 switch
9a, 9b common terminal
9c, 9d selection terminal
10 switch
10a, 10b common terminal
10c, 10d selection terminal
11 first duplexer
11a input/output part
11b input part
11c output part
11R reception filter
11T transmission filter
12 second duplexer
12a input/output part
12b input part
12c output part
12R reception filter
12T transmission filter
13 second duplexer
13a input/output part
13b input part
13c output part
13R reception filter
13T transmission filter
14, 15 filter
14a, 15a first input/output part
14b, 15b second input/output part
17, 18 power amplifier
17a, 18a input part
17b, 18b output part
20 low-noise amplifier (first low-noise amplifier)
20a input part
20b output part
21 to 24 low-noise amplifier
21a to 24a input part
21b to 24b output part
25 communication apparatus
30 second low-noise amplifier
30a input part
30b output part
40 demultiplexer
40a input part
40b first output part
40c second output part
41 variable attenuator
41a input part
41b output part
50 coupler
51 main line
52 sub line
60 variable element
70 variable attenuator
70a input part
70b output part
81 first switch
81a to 81h external terminal
82 first switch
82a common terminal (first common terminal)
82b selection terminal (first selection terminal)
82c selection terminal (second selection terminal)
82d, 82e selection terminal
83 second switch
83a common terminal (second common terminal)
83b selection terminal (third selection terminal)
83c selection terminal (fourth selection terminal)
84 first filter
84a input part
84b output part
85 triplexer
86 second filter
86a input part
86b output part
87 fourth filter
87a input part
87b output part
88 fifth filter
88a input part
88b output part
89 third filter
89a input part
89b output part
90 first low-noise amplifier
90a input part
90b output part
91 second low-noise amplifier
91a input part
91b output part
92 third low-noise amplifier
92a input part
92b output part
93 first power amplifier
93a input part
93b output part
94 second power amplifier
94a input part
94b output part
95 duplexer
96 sixth filter
96a input part
96b output part
97 seventh filter
97a input part
97b output part
98 diplexer
99 fourth low-noise amplifier
99a input part
99b output part
100 third power amplifier
100a input part
100b output part
101, 102 duplexer
103 triplexer
104 band rejection filter
104a input part
104b output part
C1 variable capacitor
M1 first signal path
M2 second signal path
N1 branch point
R1 variable resistor

1. A radio frequency module comprising:
an antenna terminal;
switching circuitry connected to the antenna terminal;
a first filter connected to the switching circuitry, the first filter having a first passband including a transmission band of a non-terrestrial network; and
a second filter connected to the switching circuitry,
the second filter having a second passband including both a reception band of the non-terrestrial network and a reception band of a terrestrial network,
wherein the switching circuitry is configured to selectively connect the antenna terminal to the first filter and to the second filter.

2. The radio frequency module according to claim 1, wherein the transmission band of the non-terrestrial network is a transmission band of n255, and wherein the reception band of the non-terrestrial network is a reception band of n255.

3. The radio frequency module according to claim 1, wherein the reception band of the terrestrial network is a reception band of at least one of Band 75, Band 76, or Band 32.

4. The radio frequency module according to claim 1,
wherein the second passband of the second filter further includes a bandwidth of global navigation satellite system (GNSS) communication band.

5. The radio frequency module according to claim 4, further comprising:
a first low-noise amplifier connected to the second filter; and
a second low-noise amplifier on a first signal path, the second low-noise amplifier being configured to amplify a signal in the GNSS communication band, the first signal path and a second signal path branching downstream of the first low-noise amplifier.

6. The radio frequency module according to claim 4, further comprising:
a low-noise amplifier connected to the second filter;
a demultiplexer configured to
demultiplex a first signal in the GNSS communication band that is included in an output signal from the low-noise amplifier,
output the demultiplexed first signal to a first signal path,
demultiplex a second signal in at least one reception band of n255, Band 75, Band 76, or Band 32, and
output the demultiplexed second signal to a second signal path, the second signal being included in the output signal from the low-noise amplifier; and
a variable attenuator on the second signal path, the variable attenuator configured to attenuate the second signal.

7. The radio frequency module according to claim 4, further comprising:
a low-noise amplifier connected to the second filter;
a coupler having a main line and a sub line, the main line being connected to the low-noise amplifier, the sub line having electromagnetic coupling with the main line; and
a variable element provided on the sub line, the variable element configured to control a coupling amount of the electromagnetic coupling between the main line and the sub line,
wherein the coupler demultiplexes a signal in at least one reception band of n255, Band 75, Band 76, or Band 32 from an output signal from the low-noise amplifier that passes through the main line, and outputs the demultiplexed signal to the sub line.

8. The radio frequency module according to claim 7, further comprising:
a variable attenuator on the main line, the variable attenuator configured to attenuate the output signal from the low-noise amplifier that passes through the main line.

9. The radio frequency module according to claim 1, wherein the first filter and the second filter form a duplexer connected to the switching circuitry.

10. The radio frequency module according to claim 9, further comprising at least one additional duplexer or at least one additional filter connected to the switching circuitry.

11. The radio frequency module according to claim 1, wherein the switching circuitry includes
a first switch having a first common terminal connected to the antenna terminal,
a first selection terminal connected to the first filter, and
a second selection terminal connected to the second filter.

12. The radio frequency module according to claim 11,
wherein the second passband of the second filter further includes a bandwidth of a third communication band serving as a communication band for global navigation satellite system (GNSS).

13. The radio frequency module according to claim 12, further comprising:
a first output terminal;
a second output terminal;
a second switch having a second common terminal connected to the second filter, a third selection terminal connected to the first output terminal, and a fourth selection terminal connected to the second output terminal;
a first low-noise amplifier connected between the second filter and the second common terminal of the second switch;
a second low-noise amplifier connected between the third selection terminal and the first output terminal; and
a third filter,
wherein the third filter is connected between the second low-noise amplifier and the first output terminal, and
wherein a third passband of the third filter includes the bandwidth of the third communication band and does not include a bandwidth of the non-terrestrial network.

14. The radio frequency module according to claim 12, further comprising:
a first output terminal;
a second output terminal;
a second switch having a second common terminal connected to the second filter, a third selection terminal connected to the first output terminal, and a fourth selection terminal connected to the second output terminal;
a first low-noise amplifier connected between the second filter and the second common terminal;
a second low-noise amplifier connected between the third selection terminal and the first output terminal; and
a third filter,
wherein the third filter is connected between the second filter and the first low-noise amplifier, and
wherein a third passband of the third filter includes the bandwidth of the third communication band and does not include a bandwidth of the non-terrestrial network.

15. The radio frequency module according to claim 12, further comprising:
a first output terminal;
a second output terminal;
a second switch having a second common terminal connected to the second filter, a third selection terminal connected to the first output terminal, and a fourth selection terminal connected to the second output terminal;
a first low-noise amplifier connected between the second filter and the second common terminal;
a second low-noise amplifier connected between the third selection terminal and the first output terminal; and
a third filter,
wherein the third filter is connected between the second switch and the second low-noise amplifier, and
wherein a third passband of the third filter includes the bandwidth of the third communication band and does not include a bandwidth of the non-terrestrial network.

16. The radio frequency module according to claim 11, further comprising:
a fourth filter connected to the second selection terminal; and
a fifth filter connected to the second selection terminal,
wherein a fourth passband of the fourth filter includes a transmission band of a fourth communication band serving as a communication band in the non-terrestrial network, and
wherein a fifth passband of the fifth filter includes a reception band of the fourth communication band.

17. The radio frequency module according to claim 16,
wherein the fourth passband of the fourth filter further includes a transmission band of a fifth communication band serving as a communication band in the terrestrial network, and
wherein the fifth passband of the fifth filter further includes a reception band of the fifth communication band.

18. The radio frequency module according to claim 11, further comprising:
a fourth filter; and
a fifth filter,
wherein the first switch further includes
a third selection terminal connected to the fourth filter,
a fourth selection terminal connected to the fifth filter,
wherein a fourth passband of the fourth filter includes a transmission band of the fourth communication band serving as a communication band in the non-terrestrial network, and
wherein a fifth passband of the fifth filter includes a reception band of the fourth communication band.

19. The radio frequency module according to claim 18,
wherein the fourth passband of the fourth filter further includes a transmission band of a fifth communication band serving as a communication band in the terrestrial network, and
wherein the fifth passband of the fifth filter further includes a reception band of the fifth communication band.

20. A communication apparatus comprising:
the radio frequency module according to claim 1; and
signal processing circuitry connected to the radio frequency module and configured to perform signal processing on a radio frequency signal.
